(19) United States
(12) Patent Application Publication
(10) Pub. No.: US 2022/0197043 A1
(43) Pub. Date: Jun. 23, 2022

(54) THREE-DIMENSIONAL BEAM STEERING DEVICE

(71) Applicant: Facebook Technologies, LLC, Menlo Park, CA (US)

(72) Inventors: Changwon JANG, Seattle, WA (US); Afsoon JAMALI, Issaquah, WA (US)

(21) Appl. No.: 17/131,708

(22) Filed: Dec. 22, 2020

(51) Int. Cl. G02B 27/28; G02B 27/00; G02B 5/30; G02B 5/32

(52) U.S. Cl. CPC G02B 27/283; G02B 5/32; G02B 5/3083; G02B 27/0093

(57) ABSTRACT

A device includes a stack of a lens assembly and a steering assembly. The stack is configured to receive a beam from a first side and output the beam from a second side. The lens assembly is configured to provide an adjustable optical power to the beam. The steering assembly is configured to provide an adjustable steering angle to the beam. The device also includes a reflector configured to receive the beam output from the second side of the stack, and reflect the beam back to the second side of the stack. The beam reflected back from the reflector is incident onto the second side of the stack, and output from the first side of the stack.

### TECHNICAL FIELD

The present disclosure generally relates to optical devices and, more specifically, to a three-dimensional beam steering device.

### BACKGROUND

Beam steering devices have numerous applications in a large variety of fields, such as target tracking, three-dimensional (“3D”) imaging and sensing, free-space optical communications countermeasures, directed energy systems, fiber optic switching devices, lithography, 3D printing, etc. Conventional beam steering devices include mechanical beam steering devices such as micro electro-mechanical system (“MEMS”) mirrors, rotating mirrors or prisms, etc. Non-mechanical beam steering devices include acousto-optic deflectors, electro-optic deflectors, liquid crystal (“LC”) based beam steering devices, etc. Liquid crystals (“LCs”) have been widely implemented in beam steering devices due to their advantages of low cost, low power consumption, and simple fabrication processes. Conventional LC-based beam steering devices have two categories: a category based on a non-uniform electric field distribution in LCs induced by patterned electrodes on one or both substrates, and another category based on a periodic refractive index profile induced by multiple alignment regions or holographic recordings in a polymer-network liquid crystal composite. Desirable features of beam steering devices include compactness, high power efficiency, large steering range with options of continuous beam steering or discrete beam steering, wavelength selectivity, incident angle selectivity and/or polarization selectivity, and polarization conversion in addition to beam steering.

### SUMMARY OF THE DISCLOSURE

One aspect of the present disclosure provides a device including a stack of a lens assembly and a steering assembly. The stack is configured to receive a beam from a first side and output the beam from a second side. The lens assembly is configured to provide an adjustable optical power to the beam. The steering assembly is configured to provide an adjustable steering angle to the beam. The device also includes a reflector configured to receive the beam output from the second side of the stack, and reflect the beam back to the second side of the stack. The beam reflected back from the reflector is incident onto the second side of the stack, and output from the first side of the stack.

Another aspect of the present disclosure provides a system including an eye tracking device configured to obtain eye tracking information of an eye pupil. The system also includes a beam steering device including a stack of a lens assembly and a steering assembly, the stack configured to receive a beam from a first side and output the beam from a second side. The beam steering device also includes a reflector configured to receive the beam output from the second side of the stack, and reflect the beam back to the second side of the stack. The beam reflected back from the reflector is incident onto the second side and output from the first side of the stack. The system further includes a controller configured to control, based on the eye tracking information, the stack to adjust at least one of a steering angle provided by the steering assembly or an optical power provided by the lens assembly to steer the beam to the eye pupil.

Other aspects of the present disclosure can be understood by those skilled in the art in light of the description, the claims, and the drawings of the present disclosure.

### BRIEF DESCRIPTION OF THE DRAWINGS

The following drawings are provided for illustrative purposes according to various disclosed embodiments and are not intended to limit the scope of the present disclosure. In the drawings:

FIG. 1A schematically illustrates a diagram of a beam steering device, according to an embodiment of the present disclosure;

FIG. 1B schematically illustrates a diagram of a beam steering device, according to another embodiment of the present disclosure;

FIG. 1C schematically illustrates a diagram of a beam steering device, according to another embodiment of the present disclosure;

FIG. 1D schematically illustrates a diagram of a beam steering device, according to another embodiment of the present disclosure;

FIG. 2 schematically illustrates a diagram of a polarization selective steering assembly, according to an embodiment of the present disclosure;

FIG. 3A schematically illustrates in-plane orientations of liquid crystal (“LC”) molecules included in a Pancharatnam-Berry Phase (“PBP”) LC grating, according to an embodiment of the present disclosure;

FIG. 3B schematically illustrates out-of-plane orientations of LC molecules included in the PBP LC grating shown in FIG. 3A, according to an embodiment of the present disclosure;

FIGS. 3C and 3D schematically illustrate polarization selective diffractions of the PBP LC grating shown in FIGS. 3A and 3B, according to an embodiment of the present disclosure;

FIG. 4 schematically illustrates a diagram of a polarization selective lens assembly, according to an embodiment of the present disclosure;

FIGS. 5A and 5B schematically illustrate in-plane orientations of LC molecules included in a PBP LC lens, according to an embodiment of the present disclosure;

FIGS. 5C and 5D illustrate polarization selective defocusing/focusing of the PBP LC lens shown in FIGS. 5A and 5B, according to an embodiment of the present disclosure;

FIG. 6A schematically illustrates a diagram of a polarization selective lens assembly, according to another embodiment of the present disclosure;

FIG. 6B schematically illustrates a diagram of a polarization selective lens included in the polarization selective lens assembly shown in FIG. 6A, at a voltage-off state, according to an embodiment of the present disclosure;

FIG. 6C schematically illustrates a diagram of a polarization selective lens included in the polarization selective lens assembly shown in FIG. 6A, at a voltage-on state, according to an embodiment of the present disclosure;

FIG. 6D schematically illustrates a diagram of a polarization selective lens included in the polarization selective lens assembly shown in FIG. 6A, according to another embodiment of the present disclosure;

FIG. 6E schematically illustrates a diagram of a polarization selective lens included in the polarization selective lens assembly shown in FIG. 6A, according to another embodiment of the present disclosure;

FIG. 6F schematically illustrates a diagram of Fresnel structures of the polarization selective lens shown in FIGS. 6D and 6E, according to an embodiment of the present disclosure.

FIG. 7A schematically illustrates a diagram of a polarization selective steering assembly, according to an embodiment of the present disclosure;

FIG. 7B schematically illustrates a diagram of a polarization selective steering element included in the polarization selective steering assembly shown in FIG. 7A, according to an embodiment of the present disclosure;

FIG. 7C schematically illustrates a diagram of a polarization selective steering element included in the polarization selective steering assembly shown in FIG. 7A, according to another embodiment of the present disclosure;

FIG. 7D schematically illustrates a diagram of a polarization selective steering element included in the polarization selective steering assembly shown in FIG. 7A, according to another embodiment of the present disclosure;

FIG. 7E schematically illustrates a diagram of a polarization selective steering element included in the polarization selective steering assembly shown in FIG. 7A, according to another embodiment of the present disclosure;

FIG. 8 schematically illustrates a diagram of a display system, according to an embodiment of the present disclosure;

FIG. 9A schematically illustrates a diagram of a near-eye display (“NED”), according to an embodiment of the present disclosure; and

FIG. 9B schematically illustrates a cross-sectional view of half of the NED shown in FIG. 9A, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or exemplary configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The phrases “in-plane direction,” “in-plane orientation,” “in-plane rotation,” “in-plane alignment pattern,” and “in-plane pitch” refer to a direction, an orientation, a rotation, an alignment pattern, and a pitch in a plane of a film or a layer (e.g., a surface plane of the film or layer, or a plane parallel to the surface plane of the film or layer), respectively. The term “out-of-plane direction” or “out-of-plane orientation” indicates a direction or an orientation that is non-parallel to the plane of the film or layer (e.g., perpendicular to the surface plane of the film or layer, e.g., perpendicular to a plane parallel to the surface plane). For example, when an “in-plane” direction or orientation refers to a direction or an orientation within a surface plane, an “out-of-plane” direction or orientation may refer to a thickness direction or orientation perpendicular to the surface plane, or a direction or orientation that is not parallel with the surface plane.

The term “orthogonal” as used in “orthogonal polarizations” or the term “orthogonally” as used in “orthogonally polarized” means that an inner product of two vectors representing the two polarizations is substantially zero. For example, two lights with orthogonal polarizations or two orthogonally polarized lights may be two linearly polarized lights with polarizations in two orthogonal directions (e.g., an x-axis direction and a y-axis direction in a Cartesian coordinate system) or two circularly polarized lights with opposite handednesses (e.g., a left-handed circularly polarized light and a right-handed circularly polarized light).

In the present disclosure, an angle of a beam (e.g., a diffraction angle of a diffracted beam, an incidence angle of an incident beam, or a steering angle of an incident beam) with respect to a normal of a surface can be defined as a positive angle or a negative angle, depending on the positional relationship between a propagation direction of the beam and the normal of the surface. For example, when the propagation direction of the beam is clockwise from the normal, the angle of the propagation direction may be defined as a positive angle, and when the propagation direction of the beam is counter-clockwise from the normal, the angle of the propagation direction may be defined as a negative angle.

The wavelength ranges, spectra, or bands mentioned in the present disclosure are for illustrative purposes. The disclosed optical device, system, element, assembly, and method may be applied to a visible wavelength range, as well as other wavelength ranges, such as an ultraviolet (“UV”) wavelength range, an infrared (“IR”) wavelength range, or a combination thereof.

The present disclosure provides a beam steering device for providing a three-dimensional (“3D”) beam steering, which may be implemented in various applications, such as pupil shifting devices, adaptive headlights, diagnostic/ophthalmic devices, spectroscopic devices, 3D printing, 3D imaging, light detection and ranging (“Lidar”), etc. The beam steering device may include at least a reflector, a polarization selective steering assembly including a plurality of steering elements (e.g., gratings, prisms, etc.), and a polarization selective lens assembly including a plurality of lenses. The polarization selective steering assembly and the polarization selective lens assembly may form a stack. The stack may include a first side and an opposing second side. A beam (e.g., an image light) may be incident onto the stack from the first side, propagate through the polarization selective steering assembly and the polarization selective lens assembly included in the stack, and exit the stack from the second side of the stack. This process may be referred to as the beam propagating through the stack for a first time. The beam output from the second side of the stack may be incident onto the reflector. The reflector may at least partially reflect the beam back to the second side of the stack. The beam reflected by the reflector may be incident onto the stack from the second side, propagate through the polarization selective steering assembly and the polarization selective lens assembly included in the stack, and exit the stack from the first side. This process may be referred to as the beam propagating though the stack for a second time.

The reflector may be any suitable optical element configured to at least partially reflect the beam through any suitable mechanisms, such as reflection, deflection, diffraction, etc. In some embodiments, the reflector may maintain the polarization of the beam when reflecting the beam back to the stack of the polarization selective steering assembly and the polarization selective lens assembly. The reflector may be operated independently or in combination with one or more additional optical elements (such as quarter-wave plate (“QWP”), and/or switchable half-wave plate (“SHWP”), etc.), such that the beam incident onto the polarization selective lens assembly for the first time and the second time may have the same polarization (e.g., a first polarization), and the beam incident onto the polarization selective steering assembly for the first time and the second time may have the same polarization (e.g., a second polarization). The first polarization may be the same as or different from the second polarization.

By guiding the beam to propagate through the stack for two times, configuring the beam incident onto the polarization selective lens assembly for the first time and the second time to have the same polarization (e.g., a first polarization), and configuring the beam incident onto the polarization selective steering assembly for the first time and the second time to have the same polarization (e.g., a second polarization), the beam may be steered for two times toward a predetermined side (e.g., left side or right side) of a normal of a surface (also referred to as a “surface normal”) of the stack by the polarization selective steering assembly, and the beam may be converged (or focused) or diverged (or defocused) for two times by the polarization selective lens assembly. Thus, a steering angle of the beam output from the stack may be increased, and the convergence (or focusing) or the divergence (or defocusing) of the beam may be increased as compared to a conventional configuration where the beam is guided through the polarization selective steering assembly and the polarization selective lens assembly for only one time. The polarization selective steering assembly and the polarization selective lens assembly may be disposed to be substantially in parallel. The polarization selective steering assembly may be configured to steer the beam in one or two directions within a plane (e.g., an x-y plane) parallel to a surface of the polarization selective steering assembly. The polarization selective lens assembly may be configured to shift the focus of the beam in a direction perpendicular to a surface of the polarization selective lens assembly. Therefore, the disclosed beam steering device may achieve a 3D beam steering.

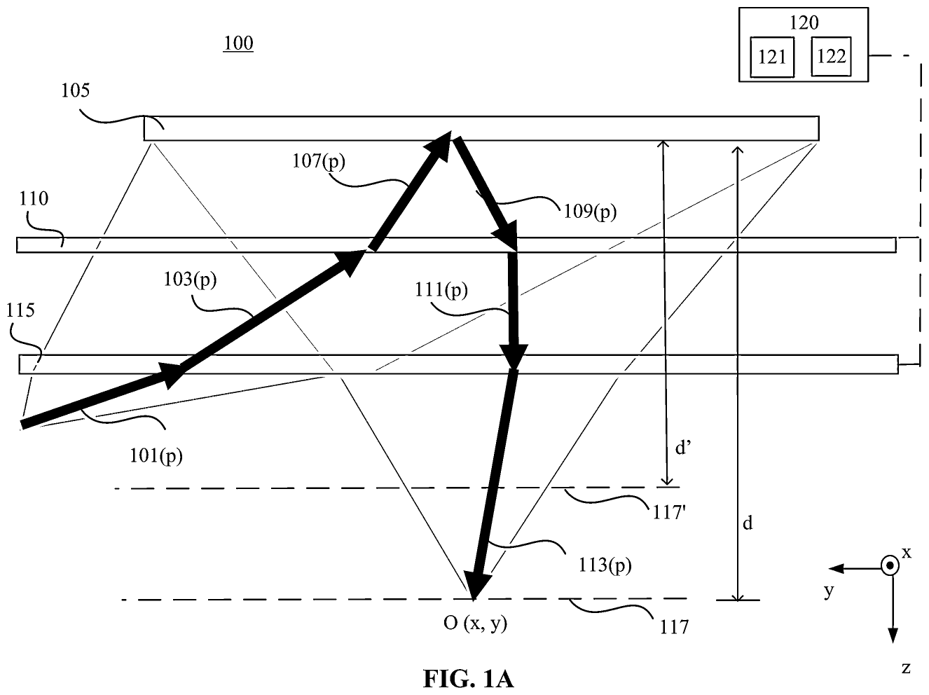

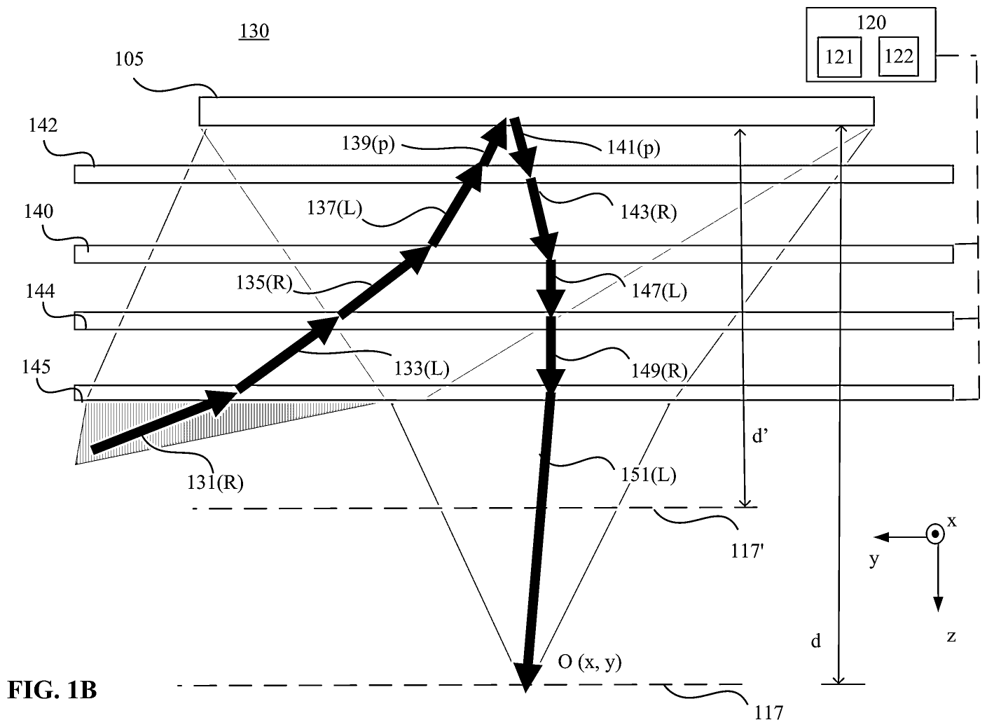

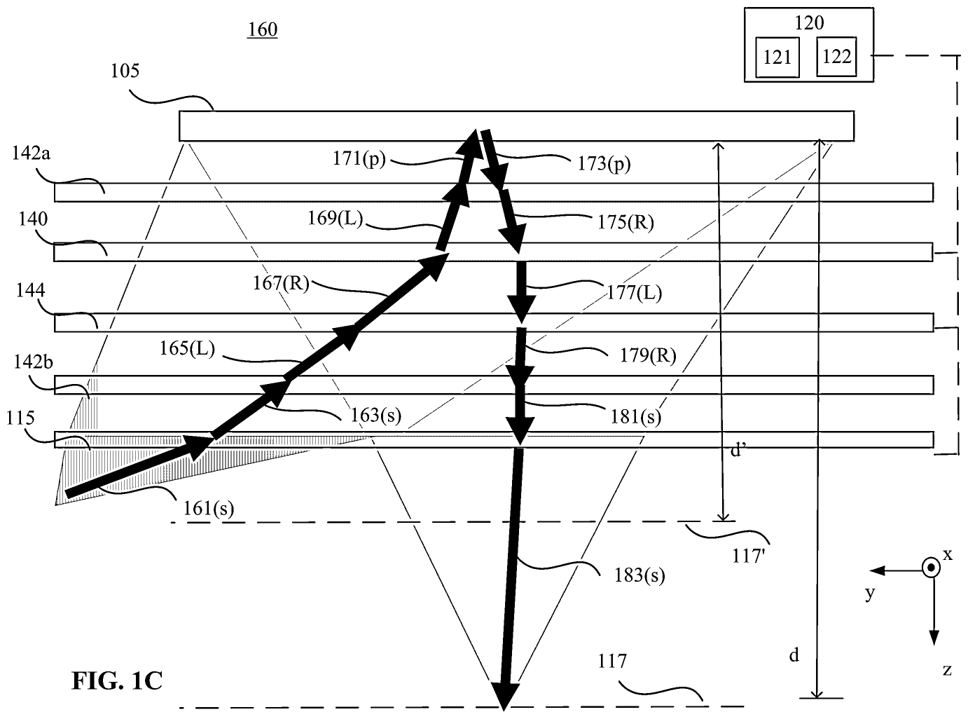

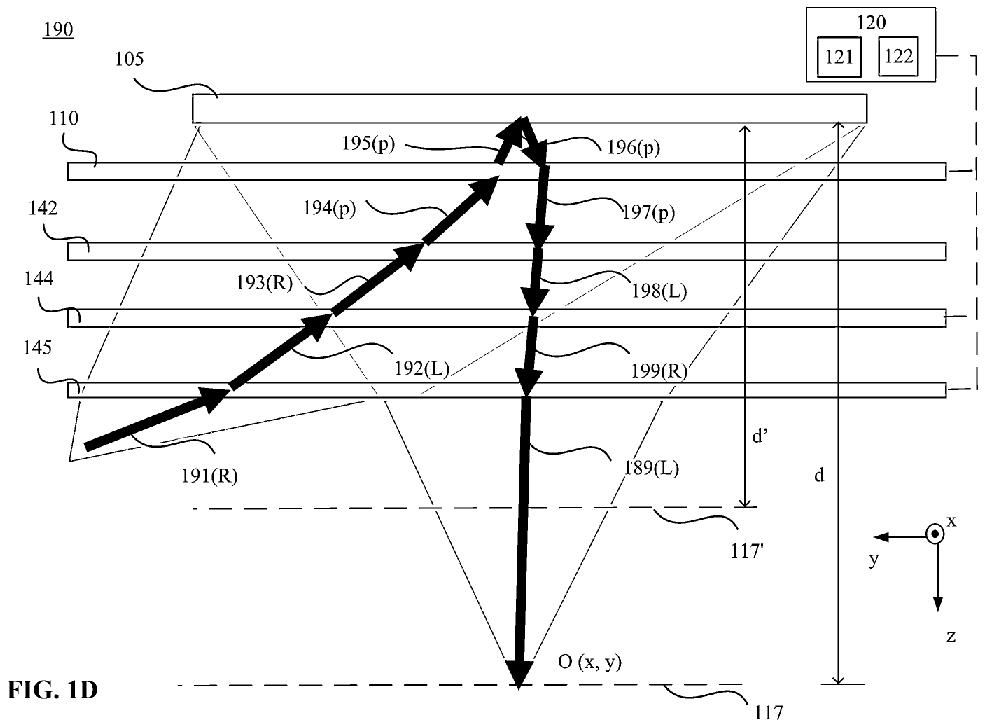

FIG. 1A schematically illustrates a diagram of a beam steering device 100 configured to provide a three-dimensional (“3D”) beam steering, according to an embodiment of the present disclosure. As shown in FIG. 1A, the beam steering device 100 may include a reflector 105, a polarization selective steering assembly 110, and a polarization selective lens assembly 115 arranged in an optical series. In some embodiments, the polarization selective steering assembly 110 may be disposed between the reflector 105 and the polarization selective lens assembly 115. The polarization selective steering assembly 110 and the polarization selective lens assembly 115 may be disposed at a same side of the reflector 105. For example, in some embodiments, the reflector 105 may have a first side facing a light source (not shown in FIG. 1A) configured to generate an input beam for the beam steering device 100 and a second side opposite to the first side. In some embodiments, the polarization selective steering assembly 110 and the polarization selective lens assembly 115 may be disposed at the first side of the reflector 105. For example, the polarization selective steering assembly 110 and the polarization selective lens assembly 115 may be disposed at the same side as the light source (or an input beam) with respect to the reflector 105. The reflector 105 may be any suitable optical element, which may be configured to at least partially reflect an input beam through any suitable mechanisms, such as reflection, deflection, diffraction, etc. The polarization selective steering assembly 110 and the polarization selective lens assembly 115 may form a stack having a first side (e.g., the side farther away from the reflector 105) and a second side (e.g., the side closer to the reflector 105).

In some embodiments, the polarization selective steering assembly 110 may include one or more polarization selective steering elements arranged in an optical series. The polarization selective steering element may include suitable sub-wavelength structures, a birefringent or optically anisotropic material (e.g., a liquid crystal (“LC”) material), a photo-refractive holographic material, or any combination thereof. For example, in some embodiments, the polarization selective steering element may be an LC steering element, such as an optical phased array (“OPA”), a switchable Bragg grating, a surface relief grating (“SRG”) filled with LCs (or an index matched SRG), a polarization volume hologram (“PVH”) LC grating, or a Pancharatnam-Berry Phase (“PBP”) LC grating, etc. In some embodiments, the polarization selective steering element may be a metasurface steering element. In some embodiments, the polarization selective steering assembly 110 may be linear polarization selective, circular polarization selective, or elliptical polarization selective, etc. In some embodiments, the polarization selective steering assembly 110 may be configured to provide a plurality of steering states for a polarized input beam. The plurality of steering states may result in a plurality of steering angles of the polarized input beam. The plurality of steering angles provided by the polarization selective steering assembly 110 may be a result of a plurality of combinations of steering angles provided by the one or more polarization selective steering elements included in the polarization selective steering assembly 110. In other words, an overall steering angle of the polarization selective steering assembly 110 may be adjustable within a predetermined range, through adjusting the respective steering angle of the one or more polarization selective steering elements included in the polarization selective steering assembly 110.

In some embodiments, the polarization selective steering assembly 110 may be electrically switchable among the plurality of steering states. In some embodiments, the polarization selective steering elements may be configured to steer a polarized input beam along a substantially same axis, such that the polarization selective steering assembly 110 may be configured to steer the polarized input beam along a single axis. In some embodiments, at least two polarization selective steering elements may be configured to steer a polarized input beam along two different axes, such that the polarization selective steering assembly 110 may steer the polarized input beam along the two different axes. In some embodiments, the polarization selective steering assembly 110 may also include one or more other optical elements, such as one or more polarizers, and/or one or more polarization switches, etc.

In some embodiments, the polarization selective lens assembly 115 may include one or more polarization selective lenses arranged in an optical series. At least one of the polarization selective lenses may be a variable lens having an variable or adjustable optical power. The polarization selective lens may include suitable sub-wavelength structures, a birefringent or optically anisotropic material (e.g., an LC material), a photo-refractive holographic material, or any combination thereof. For example, in some embodiments, the polarization selective lens may be an LC lens, such as a gradient index (“GRIN”) LC lens, a diffractive lens (e.g., a PVH LC lens, a PBP LC lens), etc. In some embodiments, the polarization selective lens may be a metasurface lens. In some embodiments, the polarization selective lens assembly 115 may be linear polarization selective, circular polarization selective, or elliptical polarization selective, etc.

The polarization selective lens assembly 115 may be configured to provide a plurality of lensing states for a polarized input beam. The plurality of lensing states may correspond to a plurality of optical powers provided by the polarization selective lens assembly 115. The plurality of optical powers may be a result of a plurality of combinations of optical powers provided by the one or more polarization selective lenses included in the polarization selective lens assembly 115. In other words, an overall optical power of the polarization selective lens assembly 115 may be adjustable within a predetermined range through adjusting the respective optical power of the one or more polarization selective lenses. In some embodiments, the polarization selective lens assembly 115 may be electrically switchable among the plurality of lensing states. In some embodiments, the polarization selective lens assembly 115 may also include other optical elements, such as one or more polarizers, and/or one or more polarization switches, etc.

In some embodiments, the reflector 105 may be a partial reflector configured to partially reflect a polarized input beam. Before the polarized input beam is incident onto the reflector 105, the polarized input beam may have propagated through a stack of the polarization selective lens assembly 115 and the polarization selective steering assembly 110 for a first time. The reflector 105 may at least partially reflect the polarized input beam back to the stack, such that the polarized input beam may propagate through the stack for a second time. In some embodiments, the reflector 105 may include a holographic optical element (“HOE”). In some embodiments, the HOE may be configured to substantially reflect an input beam that satisfies a Bragg condition via backward diffraction, and substantially transmit an input beam that does not satisfy a Bragg condition with negligible diffraction. In some embodiments, the HOE may be configured to substantially maintain a polarization of a linearly polarized input beam when reflecting (e.g., backward diffracting) the linearly polarized input beam. For example, the HOE may be configured to substantially reflect (e.g., backward diffract) an s-polarized (or a p-polarized) input beam as an s-polarized (or a p-polarized) output beam. In some embodiments, the HOE may be configured to convert a circularly polarized input beam into a circularly polarized output beam having an orthogonal polarization. For example, the HOE may be configured to substantially reflect (e.g., backward diffract) a right-handed circularly polarized (“RHCP”) or left-handed circularly polarized (“LHCP”) input beam as an LHCP or RHCP output beam. In some embodiments, the HOE may also be configured to focus (or converge) a polarized input beam to one or more spots at an image plane in addition to reflecting (e.g., backwardly diffracting) the polarized input beam. For example, the HOE may be configured with an optical power.

In some embodiments, the beam steering device 100 may include a controller 120 communicatively coupled with the polarization selective lens assembly 115 and/or the polarization selective steering assembly 110. The controller 120 may include a processor or processing unit 121. The processor 121 may by any suitable processor, such as a central processing unit (“CPU”), a graphic processing unit (“GPU”), etc. The controller 120 may include a storage device 122. The storage device 122 may be a non-transitory computer-readable medium, such as a memory, a hard disk, etc. The storage device 122 may be configured to store data or information, including computer-executable program instructions or codes, which may be executed by the processor 121 to perform various controls or functions of the methods or processes disclosed herein.

The controller 120 may control the operations of the polarization selective lens assembly 115 and/or the polarization selective steering assembly 110. For example, the controller 120 may control the polarization selective steering assembly 110 to operate in one of the plurality of steering states to steer the polarized input beam in one of the plurality of steering angles. The controller 120 may control the polarization selective lens assembly 115 to operate in one of the plurality of lensing states to provide one of the plurality of optical powers to converge or diverge the polarized input beam.

The beam steering device 100 may be configured to fold the optical path of a polarized input beam 101 and steer the input beam 101 to one or more spots O at a plane (e.g., an image plane) 117 having a distance d to the reflector 105. In some embodiments, the image plane 117 may be located at the same side of the stack as the light source (not shown) or the input beam 101. In other words, the image plane 117 may be located on the first side of the stack of the polarization selective steering assembly 110 and the polarization selective lens assembly 115, the first side being the side where the input beam 101 is incident onto the stack for the first time. At different locations in the beam steering device 100, the beam 101 may be referenced with a different number (e.g., 103, 107, 109, 111, or 113). In FIG. 1A, the beam 101 is illustrated as being incident onto the stack of the polarization selective steering assembly 110 and the polarization selective lens assembly 115 from a left side of a normal of a surface (at the first side) of the stack. The normal of the surface of the stack may be perpendicular to the polarization selective steering assembly 110 and the polarization selective lens assembly 115 shown in FIG. 1A. In some embodiments, the beam 101 may be incident onto the stack from a right side of the normal of the surface (at the first side) of the stack.

In some embodiments, the polarization selective steering assembly 110 may be configured to laterally steer (or shift) the polarized input beam 101 (as an output beam 113 output from the first side of the stack) in one or two directions in a plane, e.g., an x-y plane that is parallel with the polarization selective steering assembly 110. For example, the polarization selective steering assembly 110 may steer (e.g., rotate) the beam 101 (as an output beam 113 output from the first side of the stack) in a first direction (e.g., an x-axis direction) and/or a second direction (e.g., a y-axis direction). In some embodiments, the polarization selective lens assembly 115 may be configured to shift the focus of the beam 101 (as the output beam 113) in a direction perpendicular to the polarization selective lens assembly 115. In other words, the polarization selective lens assembly 115 may shift the image plane 117 at which the polarized input beam 101 is focused in a third direction (e.g., in a z-axis direction) that is perpendicular to the polarization selective lens assembly 115. Thus, a 3D beam steering of the polarized input beam 101 may be realized by the beam steering device 100.

In some embodiments, the distance d between the image plane 117 (at which the polarized input beam 101 is focused by the beam steering device 100) and the reflector 105 may be referred to as an image distance. In some embodiments, the image distance d may be adjustable through adjusting the optical power (or switching the lensing state) of the polarization selective lens assembly 115. An adjustment range of the image distance din the third dimension (e.g., in the z-axis direction) may be determined by the adjustment range of the overall optical power of the polarization selective lens assembly 115. In some embodiments, a lateral position (e.g., x and y coordinates) of the spot O (at the image plane 117) to which the polarized input beam 101 is steered by the beam steering device 100 may be adjustable through adjusting the steering angle (or switching the steering state) of the polarization selective steering assembly 110.

In some embodiments, the beam steering device 100 may also include one or more optical elements, such as a half-wave plate, and/or a quarter-wave plate, etc. In some embodiments, the reflector 105 may be operated independently or may be operated in combination with the one or more optical elements, such that a polarized beam incident onto the polarization selective lens assembly 115 for the first time and the second time may have the same polarization (e.g., a first polarization). That is, the beams incident onto the polarization selective lens assembly 115 from different (e.g., opposite) sides of the polarization selective lens assembly 115 may have the same polarization. In some embodiments, a polarized beam incident onto the polarization selective steering assembly 110 for the first time and the second time may have the same polarization (e.g., a second polarization). That is, the beams incident onto the polarization selective steering assembly 110 from different (e.g., opposite) sides of the polarization selective steering assembly 110 may have the same polarization. In some embodiments, the first polarization and the second polarization may be the same type of polarization (e.g., linear polarization or circular polarization). When the first polarization and the second polarization are the same type of polarization, the first polarization may be the same as or different from the second polarization. In some embodiments, the first polarization and the second polarization may be different types of polarizations. For example, one of the first polarization and the second polarization may be a circular polarization, and the other one of the first polarization and the second polarization may be a linear polarization.

Through configuring the polarizations of the polarized beams incident onto the polarization selective lens assembly 115 for the first time and the second time from different (e.g., opposite) sides of the polarization selective lens assembly 115 to be the same polarization (e.g., the first polarization), a focusing/defocusing effect provided by the polarization selective lens assembly 115 for the polarized beam (having the first polarization) may be enhanced after the polarized beam (having the first polarization) passes through the polarization selective lens assembly 115 for two times. For example, the controller 120 may be configured to control the polarization selective lens assembly 115 to operate in one of the lensing states to provide an optical power of P to the polarized beam (having the first polarization). Thus, when the polarized beam (having the first polarization) passes through the polarization selective lens assembly 115 for two times, the polarization selective lens assembly 115 may provide a total optical power of 2P to the polarized beam (having the first polarization).

Similarly, through configuring the polarizations of the polarized beams incident onto the polarization selective steering assembly 110 for the first time and the second time from different (e.g., opposite) sides of the polarization selective steering assembly 110 to be the same polarization (e.g., the second polarization), a steering effect provided by the polarization selective steering assembly 110 for the polarized beam (having the second polarization) may be enhanced after the polarized beam (having the second polarization) passes through the polarization selective steering assembly 110 for two times. For example, the controller 120 may be configured to control the polarization selective steering assembly 110 to operate in one of the steering state to steer the polarized beam (having the second polarization) by an angle of a with respect to an initial optical path of the polarized beam (having the second polarization). Thus, when the polarized beam (having the second polarization) passes through the polarization selective steering assembly 110 for two times, the polarization selective steering assembly 110 may steer the polarized beam (having the second polarization) by a total angle of 2α with respect to the initial optical path of the polarized beam (having the second polarization). Compared to a conventional beam steering device, the polarization selective steering assembly 110 may provide an enhanced steering effect without increasing the thickness (or with a substantially smaller thickness). The polarization selective lens assembly 115 may provide an enhanced focusing/defocusing effect without increasing the thickness (or with a substantially smaller thickness). Thus, the beam steering device 100 may provide a 3D beam steering with substantially smaller weight and form factor.

In some embodiments, the reflector 105 may be configured to provide a predetermined optical power Pa to reflect and focus the polarized input beam 101 incident onto the reflector 105 to a predetermined image plane 117′ having a predetermined distance d′ to the reflector 105 in the z-axis direction. That is, when the polarization selective lens assembly 115 is not included, the reflector 105 may focus the polarized input beam 101 to the predetermined image plane 117′ having the predetermined distance d′ to the reflector 105 in the z-axis direction. The predetermined distance d′ may also be referred to as a predetermined image distance. For discussion purposes, in the embodiment shown in FIG. 1A, the polarization selective lens assembly 115 operating in the one of the lensing states is configured to provide a negative optical power to the polarized beam (having the first polarization). That is, the polarization selective lens assembly 115 operating in the one of the lensing states may be configured to defocus (or diverge) the polarized beam (having the first polarization). Thus, as shown in FIG. 1A, the image distance d of the image plane 117 at which the polarized input beam 101 is focused by the beam steering device 100 is greater than the predetermined image distance d′. In other words, the polarization selective lens assembly 115 operating in the one of the lensing states may provide a defocusing (or diverging) effect to the polarized input beam 101. Thus, the beam steering device 100 may steer and focus (or converge) the polarized input beam 101 to the spot O at the image plane 117 having the image distance d greater than the predetermined image distance d′. That is, the beam steering device 100 may shift the image plane away from the reflector 105, e.g., in a direction perpendicular to the predetermined image plane 117′. As the absolute value of the negative optical power provided by the polarization selective lens assembly 115 further increases, the polarization selective lens assembly 115 may vertically shift the image plane 117 at which the polarized input beam 101 is focused away from the reflector 105. As the absolute value of the negative optical power provided by the polarization selective lens assembly 115 further decreases, the polarization selective lens assembly 115 may vertically shift the image plane 117, at which the polarized input beam 101 is focused, toward the reflector 105.

Although not shown, in some embodiments, the controller 120 may be configured to control the polarization selective lens assembly 115 to operate in another lensing state to focus (or converge) the polarized beam (having the first polarization). Thus, the beam steering device 100 may steer and focus (or converge) the polarized input beam 101 to one or more spots O at the image plane 117 with the image distance d smaller than the predetermined image distance d′. In other words, the polarization selective lens assembly 115 operating in another lensing state may provide a focusing effect to the polarized input beam 101. As the absolute value of the positive optical power provided by the polarization selective lens assembly 115 further increases, the polarization selective lens assembly 115 may vertically shift the image plane 117, at which the polarized input beam 101 is focused, toward the reflector 105. As the absolute value of the positive optical power provided by the polarization selective lens assembly 115 further decreases, the polarization selective lens assembly 115 may vertically shift the image plane 117 at which the polarized input beam 101 is focused away from the reflector 105.

In some embodiments, the controller 120 may be configured to control the polarization selective lens assembly 115 to operate in a natural state to provide a substantially zero optical power to the polarized input beam 101. That is, the polarization selective lens assembly 115 may not focus (or converge) or defocus (or diverge) the polarized beam (having the first polarization). Thus, the beam steering device 100 may focus the polarized input beam 101 to one or more spots at the predetermined image plane 117′.

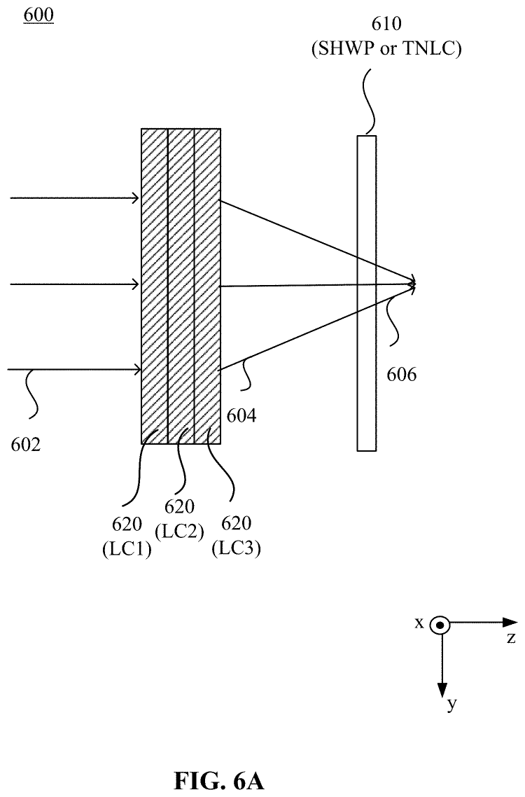

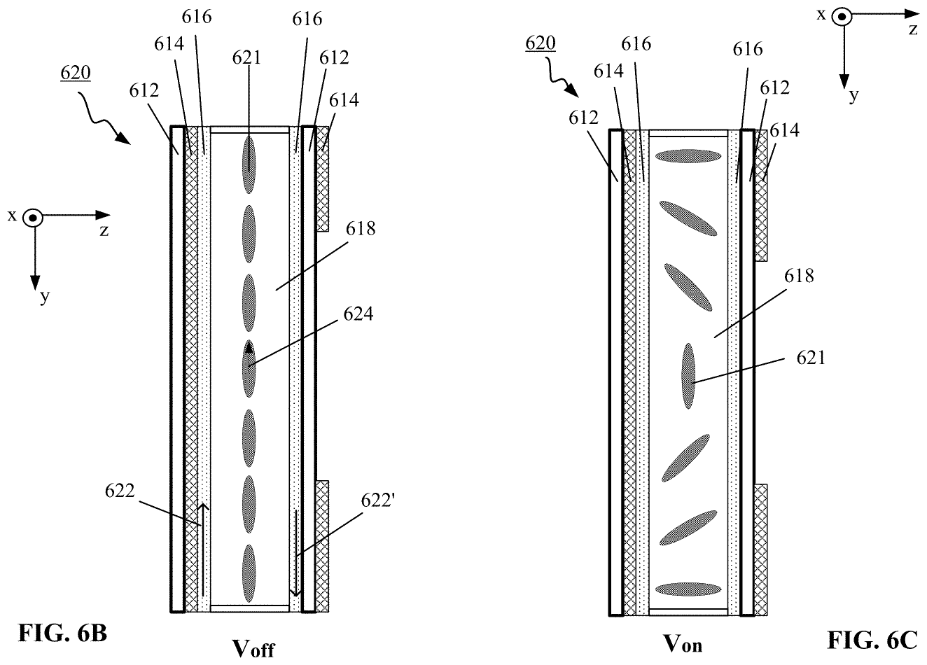

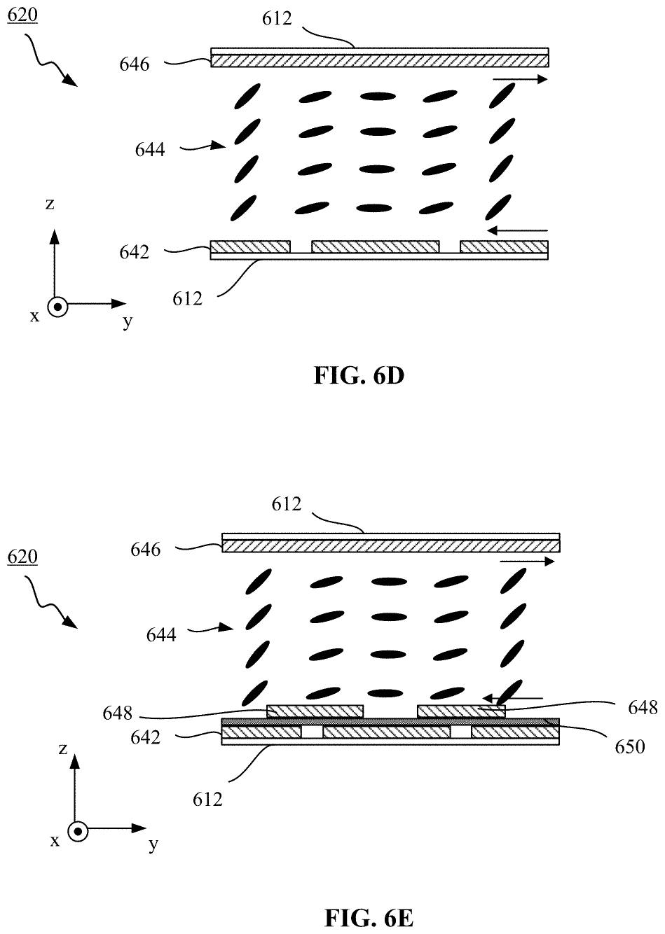

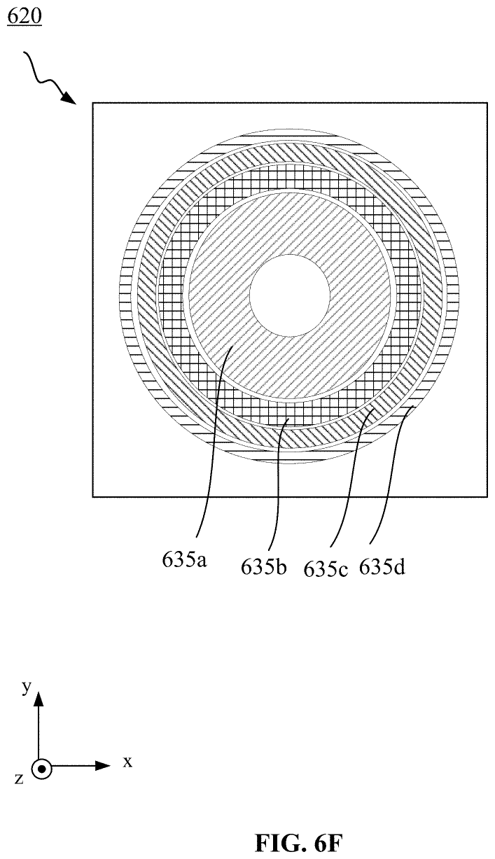

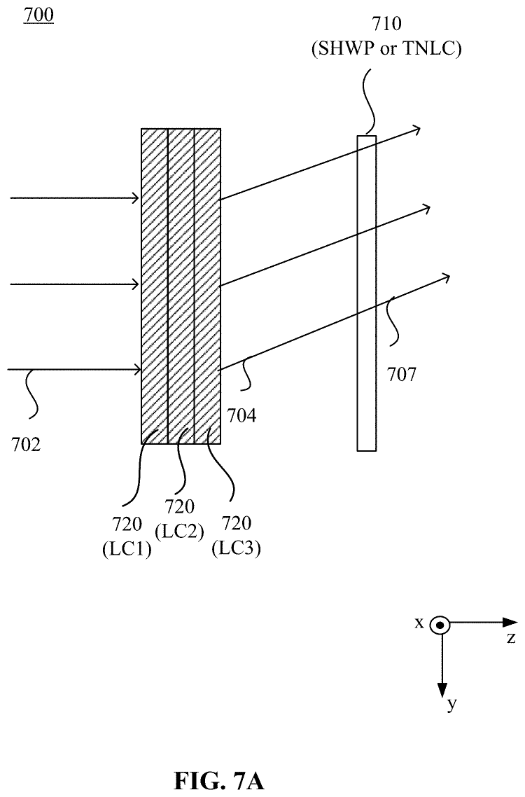

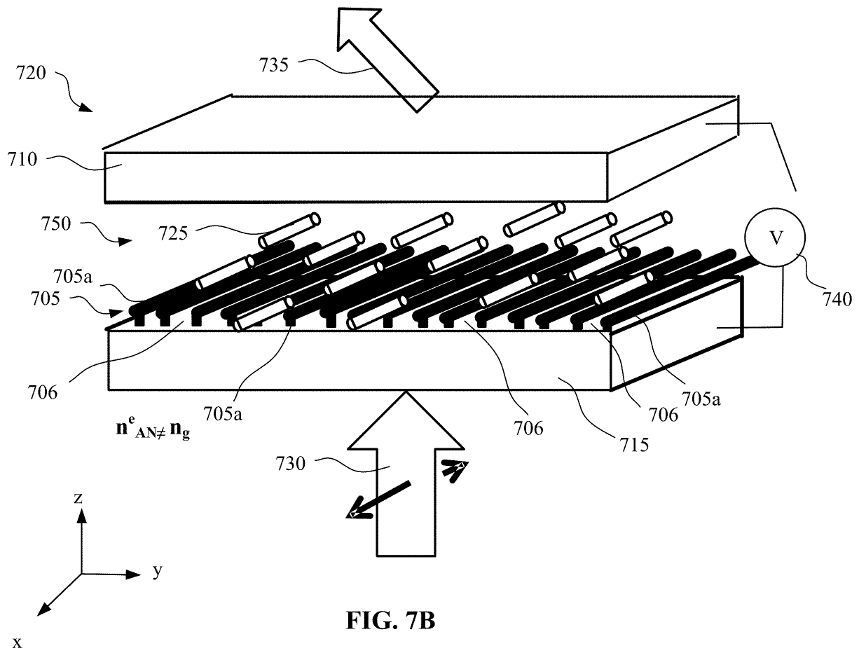

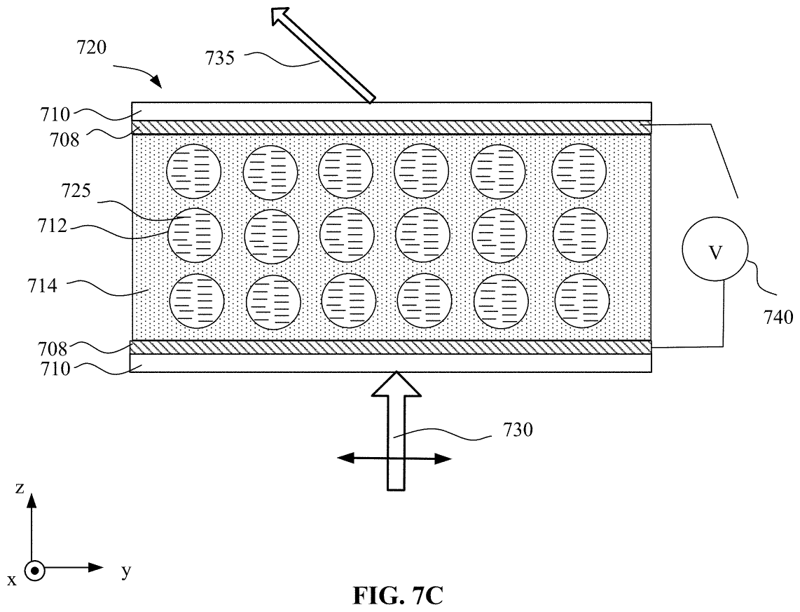

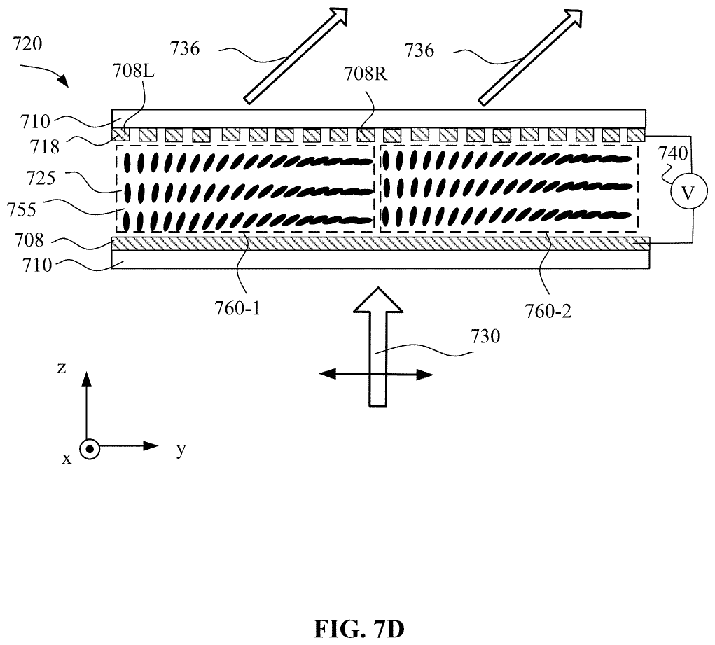

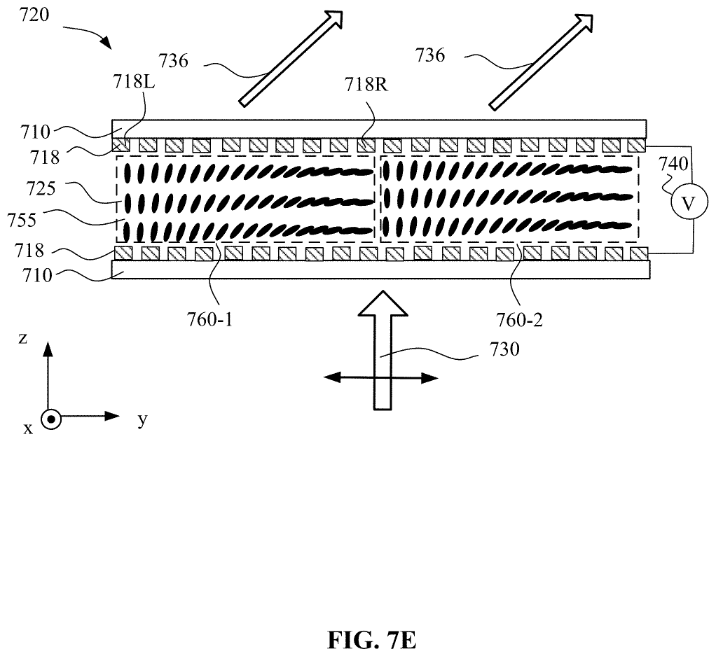

In the embodiment shown in FIG. 1A, the polarization selective steering assembly 110 and the polarization selective lens assembly 115 may be linear polarization selective. That is, the polarization selective lens assembly 115 and the polarization selective steering assembly 110 may have the same type of polarization selectivity. For example, the polarization selective steering elements included in the polarization selective steering assembly 110 and the polarization selective lenses included in the polarization selective lens assembly 115 may be linear polarization selective. In some embodiments, the polarization selective steering assembly 110 may be configured to steer a linearly polarized input beam having a first linear polarization to a plurality of different steering angles at different time periods, and function as a substantially optically uniform plate to a linearly polarized input beam having a second linear polarization. In some embodiments, the first linear polarization may be orthogonal to the second linear polarization. In some embodiments, the polarization selective lens assembly 115 may be configured to provide an optical power (which may be non-zero) for a linearly polarized input beam having the first linear polarization, and function as a substantially optically uniform plate (having a substantially zero optical power) for a linearly polarized input beam having the second linear polarization. An exemplary configuration of the polarization selective steering assembly 110 is shown in FIGS. 7A-7E, and an exemplary configuration of the polarization selective lens assembly 115 is shown in FIGS. 6A-6E.

For discussion purposes, in the embodiment shown in FIG. 1A, the polarized input beam 101 is shown as a linearly p-polarized beam. In FIG. 1A, the character “p” denotes p-polarization. The polarization selective steering assembly 110 may be configured to steer a p-polarized beam to a plurality of steering angles, and function as a substantially optically uniform plate for an s-polarized beam. The polarization selective lens assembly 115 may be configured to exhibit an optical power (which may be non-zero) for a p-polarized beam, and function as a substantially optically uniform plate (having a substantially zero optical power) for an s-polarized beam. The polarization selective steering assembly 110 and the polarization selective lens assembly 115 may be presumed to substantially maintain the polarization of a p-polarized beam after the p-polarized beam is transmitted therethrough.

As shown in FIG. 1A, the p-polarized beam 101 may be first incident onto the polarization selective lens assembly 115. The controller 120 may be configured to control the polarization selective lens assembly 115 to operate in one of the lensing states to provide an optical power of P to the p-polarized input beam 101, and output a p-polarized beam 103 propagating toward the polarization selective steering assembly 110. The polarization selective lens assembly 115 operating in the one of the lensing states may focus (or converge) or defocus (or diverge) of the p-polarized input beam 101, depending on a sign (e.g., positive or negative) of the optical power P. The controller 120 may be configured to control the polarization selective steering assembly 110 to operate in one of the steering states to forwardly steer the p-polarized beam 103, e.g., counter-clockwise (e.g., with a steering angle of a) with respect to an initial optical path of the beam 103. That is, the polarization selective steering assembly 110 may steer the beam 103 counter-clockwise toward the left side of a normal of a surface (or a surface normal) of the polarization selective steering assembly 110. In the embodiment shown in FIG. 1A, the beam 103 that is incident onto the polarization selective steering assembly 110 from the left side of the surface normal is steered by the polarization selective steering assembly 110 counter-clockwise toward the same side of the surface normal where the beam 103 is located (also the same side where the beam 101 is located).

The polarization selective steering assembly 110 may output a p-polarized beam 107 propagating toward the reflector 105. The reflector 105 may be configured to substantially maintain the polarization of the p-polarized beam 107 when reflecting (e.g., backwardly diffracting) the p-polarized beam 107 as a p-polarized beam 109 propagating toward the polarization selective steering assembly 110. The beam 109 may be incident onto the stack of the polarization selective steering assembly 110 and the polarization selective lens assembly 115 for a second time, from the second side of the stack. Thus, the beam incident ono the polarization selective steering assembly 110 for the first time (e.g., as the beam 103) and for the second time (e.g., as the beam 109) may have the same polarization, e.g., the p-polarization. In other words, the beams incident onto the polarization selective steering assembly 110 from different (e.g., opposite) sides of the polarization selective steering assembly 110 may have the same polarization. Accordingly, the polarization selective steering assembly 110 operating in the one of the steering states may be configured to forwardly steer the p-polarized beam 109 clockwise (e.g., with a steering angle of a) with respect to the initial optical path of the beam 109.

The polarization selective steering assembly 110 may output a p-polarized beam 111 propagating toward the polarization selective lens assembly 115. That is, the polarization selective steering assembly 110 may steer the beam 109 clockwise toward the left side of the surface normal of the polarization selective steering assembly 110. In the embodiment shown in FIG. 1A, the beam 109 that is incident onto the polarization selective steering assembly 110 from the left side of the surface normal is steered by the polarization selective steering assembly 110 clockwise toward the same side of the surface normal where the beam 109 is located (also the same side where the beam 101 is located). As shown in FIG. 1A, the polarization selective steering assembly 110 may have a first side facing the input beam 101 and an opposing second side. For the beams 103 and 109 respectively incident onto the polarization selective steering assembly 110 from the first and second sides, the polarization selective steering assembly 110 may steer the beams 103 and 109 toward the left side of the surface normal, which is the same side where the input beam 101 is located. Thus, after the beam 101 propagates through the polarization selective steering assembly 110 for two times, the beam 101 may be steered for two times toward the left side of the surface normal by the polarization selective steering assembly 110. Thus, the steering effect provided by the polarization selective steering assembly 110 to the input beam 101 may be enhanced.

The polarized input beam 101 incident ono the polarization selective lens assembly 115 for the first time (e.g., as the beam 101) and the second time (e.g., as the beam 111) may have the same polarization, e.g., the p-polarization. That is, the beams incident onto the polarization selective lens assembly 115 from different (e.g., opposite) sides of the polarization selective lens assembly 115 may have the same polarization. The polarization selective lens assembly 115 operating in the one of the lensing states may be configured to provide the optical power of P to the p-polarized beam 111, and output a p-polarized beam 113 that is focused to a spot O at the image plane 117.

For discussion purposes, in the embodiment shown in FIG. 1A, the polarization selective lens assembly 115 operating in the one of the lensing states is configured to provide a negative optical power to a p-polarized beam. Thus, the polarization selective lens assembly 115 operating in the one of the lensing states may be configured to defocus (or diverge) the p-polarized input beam 101 when the p-polarized input beam 101 is incident onto the polarization selective lens assembly 115 for the first time (as the p-polarized beam 101) and for the second time (as the p-polarized beam 111). In other words, the polarization selective lens assembly 115 may provide a defocusing effect to the p-polarized input beam 101, and vertically shift an image plane at which the p-polarized input beam 101 is focused away from the predetermined image plane 117′ in a direction moving away from the reflector 105. Thus, the beam steering device 100 may steer and focus the p-polarized input beam 101 to the spot O at the image plane 117 having the image distance d greater than the predetermined image distance d′.

FIG. 1B schematically illustrates a diagram of a beam steering device 130 configured to provide a 3D beam steering, according to another embodiment of the present disclosure. The beam steering device 130 may include elements similar to or the same as those included in the beam steering device 100 shown in FIG. 1A. Descriptions of the same or similar elements can refer to the above descriptions rendered in connection with FIG. 1A. As shown in FIG. 1B, the beam steering device 130 may include the reflector 105, a first waveplate 142, a polarization selective steering assembly 140, a second waveplate 144, and a polarization selective lens assembly 145 arranged in an optical series (e.g., stacked together). In some embodiments, the first waveplate 142 may be disposed between the reflector 105 and the polarization selective steering assembly 140, and the second waveplate 144 may be disposed between the polarization selective steering assembly 140 and the polarization selective lens assembly 145. In some embodiments, the reflector 105 may have a first side facing a light source (not shown in FIG. 1B) configured to emit an input beam for the beam steering device 130 and a second side opposite to the first side. In some embodiments, the first waveplate 142, the polarization selective steering assembly 140, the second waveplate 144, and the polarization selective lens assembly 145 may be disposed at the first side of the reflector 105, i.e., at the same side as the light source.

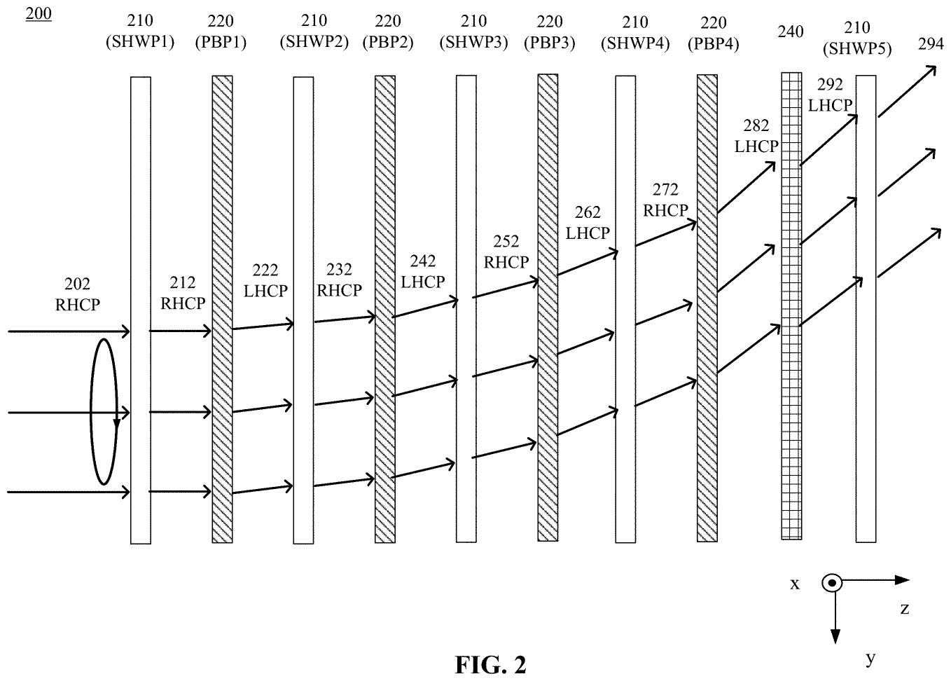

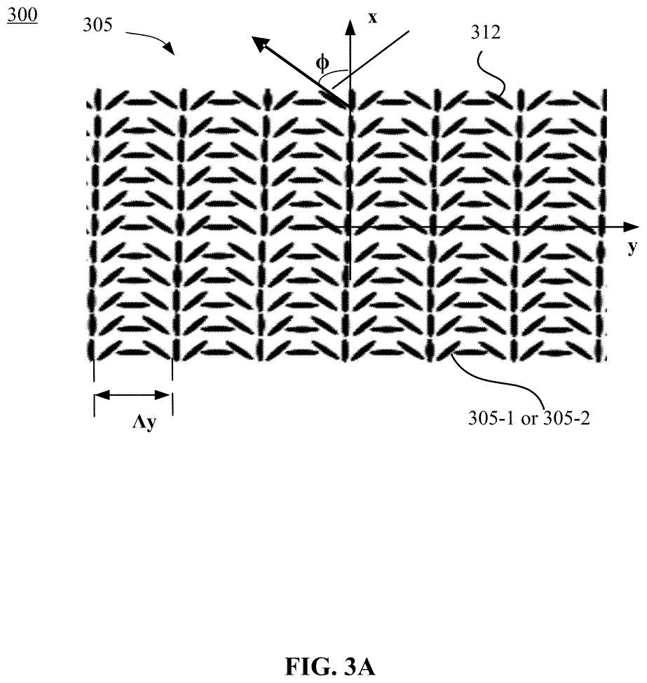

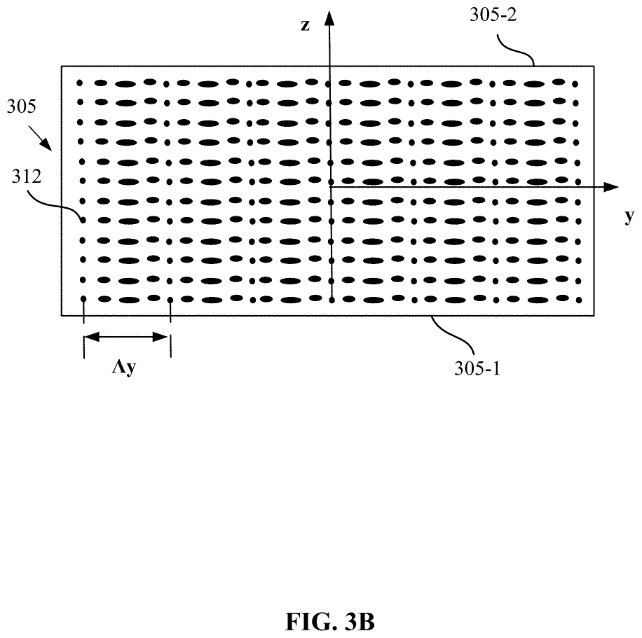

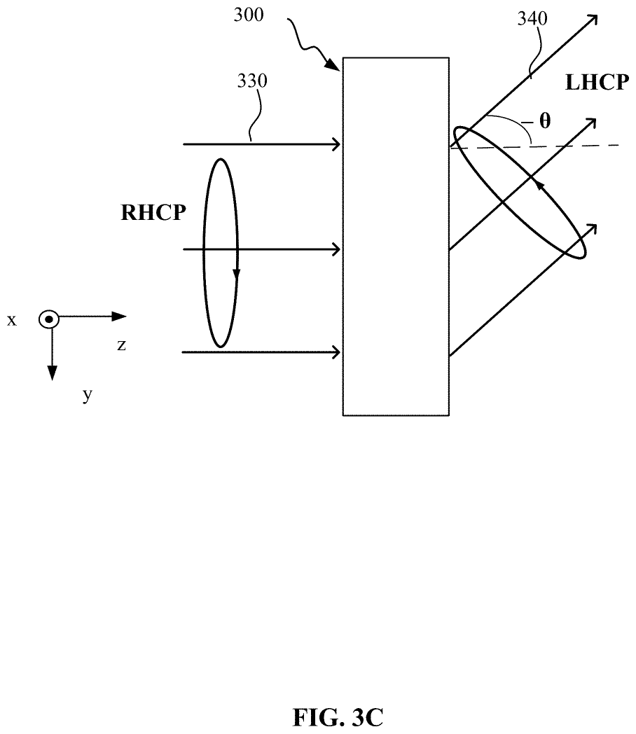

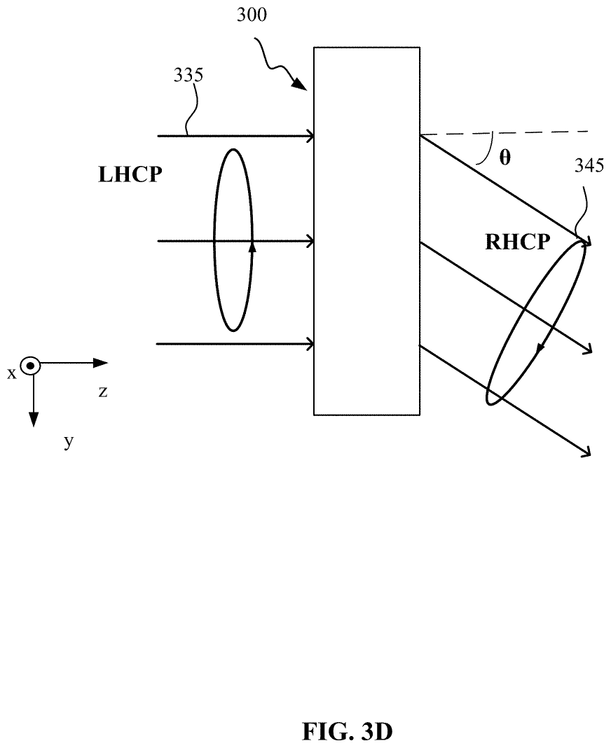

In the embodiment shown in FIG. 1B, both the polarization selective steering assembly 140 and the polarization selective lens assembly 145 may be circular polarization selective. That is, the polarization selective lens assembly 145 and the polarization selective steering assembly 140 may have the same type of polarization selectivity. For example, the polarization selective steering assembly 140 may be configured to provide a plurality of steering states for a circularly polarized beam. The plurality of steering states may result in a plurality of steering angels of the circularly polarized beam. In some embodiments, the controller 120 may be communicatively coupled with the polarization selective steering assembly 140 to control the polarization selective steering assembly 140 to switch among the plurality of steering states. In some embodiments, the polarization selective steering assembly 140 may include one or more circular polarization selective steering elements arranged in an optical series (e.g., in a stack). In some embodiments, the circular polarization selective steering element may be a PBP LC grating configured to operate in a first (e.g., positive) state to diffract a circularly polarized beam having a first handedness to a positive angle and operate in a second (e.g., negative) state to diffract a circularly polarized beam having a second handedness to a negative angle. The first handedness may be orthogonal to the second handedness. In some embodiments, the PBP LC grating may also be configured to operate in a third (e.g., neutral) state to substantially maintain a propagation direction of a circularly polarized beam independent of the handedness. In some embodiments, the polarization selective steering elements included in the polarization selective steering assembly 140 may be configured to steer a circular polarized beam along a substantially same axis, such that the circular polarized beam may be steered along a single axis. In some embodiments, at least two polarization selective steering elements included in the polarization selective steering assembly 140 may be configured to steer a circular polarized beam along two different axes, such that the circular polarized beam may be steered along two different axes (e.g., in two different directions). In some embodiments, the polarization selective steering assembly 140 may also include one or more other optical elements, such as one or more polarizers, and/or one or more polarization switches, etc. An exemplary configuration of the polarization selective steering assembly 140 is shown in FIGS. 2-3D.

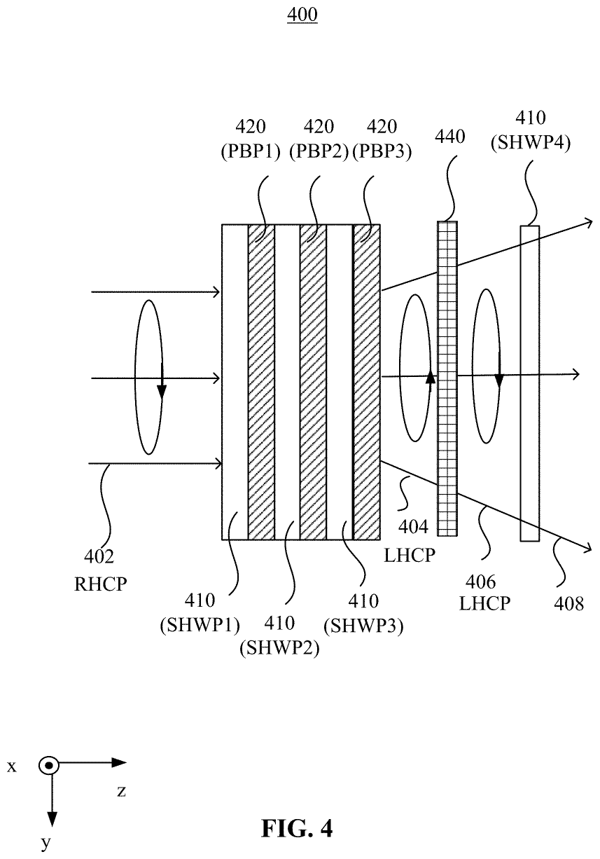

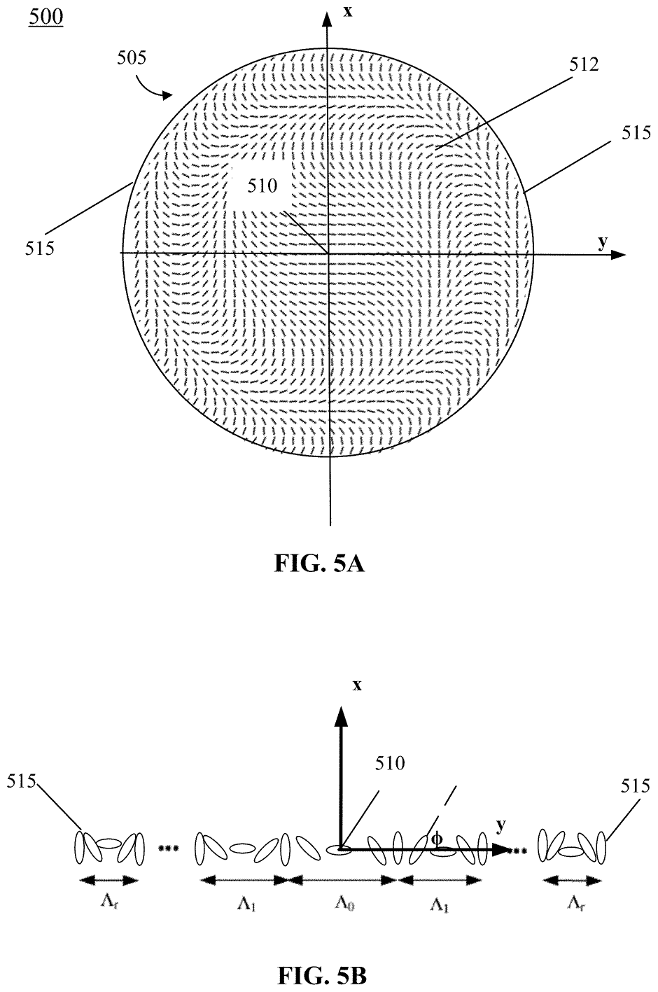

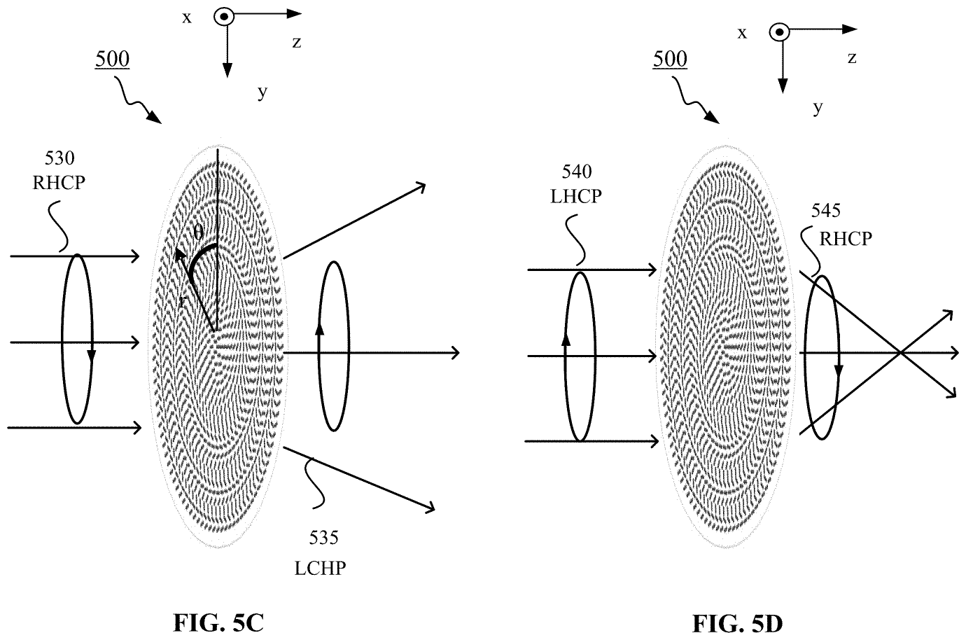

In some embodiments, the polarization selective lens assembly 145 may include one or more circular polarization selective lenses arranged in an optical series (e.g., in a stack). In some embodiments, the circular polarization selective lens may be a PBP LC lens configured to operate in a focusing (or converging) state to focus (or converge) a circularly polarized beam having a first handedness, and operate in a defocusing (or diverging) state to defocus (or diverge) a circularly polarized beam having a second handedness. The first handedness may be opposite to the second handedness. In some embodiments, the PBP LC lens may also be configured to operate in a neutral state to substantially maintain a propagation direction of a circularly polarized beam independent of the handedness. In some embodiments, the polarization selective lens assembly 145 may also include one or more other optical elements, such as one or more polarizers, and/or one or more polarization switches, etc. The polarization selective lens assembly 145 may be configured to provide a plurality of lensing states for a circularly polarized input beam. The plurality of lensing states may correspond to a plurality of optical powers provided by the polarization selective lens assembly 145. The plurality of optical powers may be a result of a plurality of combinations of optical powers provided by the individual polarization selective lenses included in the polarization selective lens assembly 145. In other words, an overall optical power of the polarization selective lens assembly 145 may be adjustable within a predetermined range through adjusting the individual optical power of the polarization selective lenses. In some embodiments, the controller 120 may be communicatively coupled with the polarization selective lens assembly 145 to control the polarization selective lens assembly 145 to switch among the plurality of lensing states. An exemplary configuration of the polarization selective lens assembly 145 is shown in FIGS. 4-5D.

In some embodiments, the first waveplate 142 may function as a quarter-wave plate (“QWP”) to provide a quarter-wave retardance for a beam having a wavelength within a predetermined wavelength range and an incidence angle within a predetermined incidence angle range. The first waveplate 142 may be configured to convert a linearly polarized beam into a circularly polarized beam or convert a circularly polarized beam into a linearly polarized beam. For example, the first waveplate 142 may have a polarization axis that is oriented relative to the polarization direction of the linearly polarized beam to convert the linearly polarized beam into a circularly polarized beam. In some embodiments, for an achromatic design, the first waveplate 142 may include a multi-layer birefringent material (e.g., a polymer or LCs) configured to produce a quarter-wave birefringence across a wide spectrum (or wavelength range). In some embodiments, for a monochrome design, an angle between the polarization axis (e.g., fast axis) of the first waveplate 142 and the polarization direction of the linearly polarized beam may be about 45°. In some embodiments, the first waveplate 142 may be included in the polarization selective steering assembly 140.

In some embodiments, the second waveplate 144 may function as a half-wave plate (“HWP”) for a beam having a wavelength within a predetermined wavelength range and an incidence angle within a predetermined incidence angle range. In some embodiments, the HWP may be a switchable half-wave plate (“SHWP”) configured to be switchable by the controller 120 between two operating states: a switching state and a non-switching state. The SHWP operating in the switching state may switch a polarization of a polarized beam to an orthogonal polarization, e.g., switch a linearly polarized beam having a first polarization to a linearly polarized beam having a second polarization orthogonal to the first polarization, or switch a circularly polarized beam having a first handedness to a circularly polarized beam having a second handedness opposite to the first handedness, etc. The SHWP operating in the non-switching state may maintain the polarization of the polarized beam. In some embodiments, the SHWP may include an LC layer and one or more electrodes. An external electric field (e.g., a voltage) may be applied to the LC layer through the electrodes to change the orientation of the LCs, thereby controlling the SHWP to operate in a switching state or in a non-switching state. For example, the SHWP may operate in the switching state when the applied voltage is lower than or equal to a predetermined voltage value, or operate in the non-switching state when the voltage is higher than the predetermined voltage value (and sufficiently high) to reorient the LC directors along the electric field direction. In some embodiments, the controller 120 may be communicatively coupled with the second waveplate 144 to control the operation states of the second waveplate 144 functioning as an SHWP. In some embodiments, the second waveplate 144 may be included in one of the polarization selective lens assembly 145 and the polarization selective steering assembly 140.

For discussion purposes, in the embodiment shown in FIG. 1B, an input beam 131 of the beam steering device 130 may be an RHCP beam. In FIG. 1B, the character “p” denotes that the corresponding beam is a p-polarized beam, the character “R” denotes that the corresponding beam is an RHCP beam, and the character “L” denotes that the corresponding beam is a an LHCP beam. The RHCP beam 131 may be first incident onto the polarization selective lens assembly 145. The controller 120 may be configured to control the polarization selective lens assembly 145 to operate in one of the lensing states to provide an optical power of P to the RHCP beam 131. The polarization selective lens assembly 145 operating in the one of the lensing states may focus (or converge) or defocus (or diverge) the RHCP beam 131, depending on a sign (e.g., positive or negative) of the optical power P. In addition, the polarization selective lens assembly 145 operating in the one of the lensing states may be configured to output a circularly polarized beam having a handedness that is the same as or opposite to the handedness of the RHCP beam 131. For discussion purposes, FIG. 1B shows that the polarization selective lens assembly 145 is configured to provide a negative optical power to defocus (or diverge) the RHCP beam 131 as an LHCP beam 133 having a handedness that is opposite to the handedness of the RHCP beam 131. The LHCP beam 133 may propagate toward the second waveplate 144.

The controller 120 may be configured to control the second waveplate 144 to operate in the non-switching state to maintain the polarization of the LHCP beam 133, or operate in the switching state to convert the LHCP beam 133 into an RHCP beam. For discussion purposes, in the embodiment shown in FIG. 1B, the controller 120 is configured to control the second waveplate 144 to operate in the switching state to convert the LHCP beam 133 into an RHCP beam 135 propagating toward the polarization selective steering assembly 140. The controller 120 may be configured to control the polarization selective steering assembly 140 to operate in one of the steering states to forwardly steer the RHCP beam 135, e.g., counter-clockwise (e.g., with a steering angle of a) with respect to an initial optical path of the beam 135. The polarization selective steering assembly 140 operating in the one of the steering states may output a circularly polarized beam having a handedness that is the same as or opposite to the handedness of the RHCP beam 135. For discussion purposes, FIG. 1B shows that the polarization selective steering assembly 140 is configured to output an LHCP beam 137 having a handedness that is opposite to the handedness of the RHCP beam 135. The LHCP beam 137 may propagate toward the first waveplate (e.g., QWP) 142. The first waveplate (e.g., QWP) 142 may be configured to convert the LHCP beam 137 into a linearly polarized beam. For discussion purposes, FIG. 1B shows that the first waveplate (e.g., QWP) 142 is configured to convert the LHCP beam 137 into a p-polarized beam 139 propagating toward the reflector 105.

The reflector 105 may be configured to substantially maintain the polarization of the p-polarized beam 139 when reflecting (e.g., backwardly diffracting) the p-polarized beam 139 as a p-polarized beam 141 propagating toward the first waveplate 142. The first waveplate (e.g., QWP) 142 may be configured to convert the p-polarized beam 141 into an RHCP beam 143 propagating toward the polarization selective steering assembly 140. That is, a stack of the first waveplate (e.g., QWP) 142 and the reflector 105 may be configured to convert the LHCP beam 137 output from the polarization selective steering assembly 140 into a circularly polarized beam 143 having an orthogonal polarization (e.g., RHCP), after the LHCP beam 137 is transmitted through the first waveplate (e.g., QWP) 142 for the first time, reflected (e.g., backwardly diffracted) by the reflector 105 back to the first waveplate (e.g., QWP) 142, and transmitted through the first waveplate (e.g., QWP) 142 for the second time toward the polarization selective steering assembly 140.

Thus, the polarized input beam 131 incident ono the polarization selective steering assembly 140 for the first time (e.g., as the beam 135) and the second time (e.g., as the beam 143) may have the same polarization, e.g., the right-handed circular polarization. That is, the beams incident onto the polarization selective steering assembly 140 from different (e.g., opposite) sides of the polarization selective steering assembly 140 may have the same polarization. The polarization selective steering assembly 140 operating in the one of the steering states may be configured to forwardly steer the RHCP beam 143 clockwise (e.g., with a steering angle of a) with respect to the initial optical path of the input beam 143, and output an LHCP beam 147 having a handedness that is opposite to the handedness of the RHCP beam 143. The second waveplate (e.g., SHWP) 144 operating in the switching state may convert the LHCP beam 147 into an RHCP beam 149 propagating toward the polarization selective lens assembly 145. Thus, the polarized input beam 131 incident ono the polarization selective lens assembly 145 for the first time (e.g., as the beam 131) and the second time (e.g., as the beam 149) may have the same polarization, e.g., the right-handed circular polarization. That is, the beams incident onto the polarization selective lens assembly 145 from different (e.g., opposite) sides of the polarization selective lens assembly 145 may have the same polarization. The polarization selective lens assembly 145 operating in the one of the lensing states may be configured to provide the optical power of P to the RHCP beam 149, and output an LHCP beam 151 that is focused to a spot O at the image plane 117.

For discussion purposes, in the embodiment shown in FIG. 1B, the polarization selective lens assembly 145 operating in the one of the lensing states is configured to provide a negative optical power to an RHCP beam. Thus, the polarization selective lens assembly 145 may be configured to defocus (or diverge) the RHCP input beam 131 when the RHCP input beam 131 is incident onto the polarization selective lens assembly 145 for the first time (e.g., as the RHCP beam 131) and the second time (e.g., as the RHCP beam 149). In other words, the polarization selective lens assembly 145 may provide a defocusing effect to the RHCP input beam 131. Thus, the beam steering device 130 may steer and focus the RHCP input beam 131 to the spot O at the image plane 117 having the image distance d greater than the predetermined image distance d′.

FIG. 1C schematically illustrates a diagram of a beam steering device 160 configured to provide a 3D beam steering, according to another embodiment of the present disclosure. The beam steering device 160 may include elements similar to or the same as those included in the beam steering device 100 shown in FIG. 1A or the beam steering device 130 shown in FIG. 1B. Descriptions of the same or similar elements can refer to the above descriptions rendered in connection with FIG. 1A or FIG. 1B. As shown in FIG. 1C, the beam steering device 160 may include the reflector 105, a first waveplate 142a, the polarization selective steering assembly 140, the second waveplate 144, a third waveplate 142b, and the polarization selective lens assembly 115 arranged in an optical series (e.g., in a stack). In some embodiments, the first waveplate 142a may be disposed between the reflector 105 and the polarization selective steering assembly 140. The polarization selective steering assembly 140 may be disposed between the first waveplate 142a and the second waveplate 144. The second waveplate 144 may be disposed between the polarization selective steering assembly 140 and the third waveplate 142b. The third waveplate 142b may be disposed between the second waveplate 144 and the polarization selective lens assembly 115.

In the embodiment shown in FIG. 1C, the polarization selective lens assembly 115 may be linear polarization selective, and the polarization selective steering assembly 140 may be circular polarization selective. That is, the polarization selective lens assembly 115 and the polarization selective steering assembly 140 may have different types of polarization selectivities. The second waveplate 144 may function as an SHWP for an input beam having a wavelength within a predetermined wavelength range and an incidence angle within a predetermined incidence angle range. In some embodiments, the second waveplate 144 functioning as an SHWP may be included in the polarization selective steering assembly 140. In some embodiments, each of the first waveplate 142a and the third waveplate 142b may function as a QWP for an input beam having a wavelength within a predetermined wavelength range and an incidence angle within a predetermined incidence angle range. The first waveplate 142a and the third waveplate 142b may be similar to the first waveplate 142 shown in FIG. 1B. Descriptions of the polarization selective lens assembly 115, the polarization selective steering assembly 140, the second waveplate 144, the first waveplate 142a, and the third waveplate 142b can refer to the above descriptions rendered in connection with FIGS. 1A and 1B.

For discussion purposes, in the embodiment shown in FIG. 1C, an input beam 161 incident onto the beam steering device 160 may be an s-polarized beam. In FIG. 1C, the character “p” denotes that the corresponding beam is a p-polarized beam, the character “s” denotes that the corresponding beam is an s-polarized beam, the character “R” denotes that the corresponding beam is an RHCP beam, and the character “L” denotes that the corresponding beam is an LHCP beam. The s-polarized beam 161 may be first incident onto the polarization selective lens assembly 115. The controller 120 may be configured to control the polarization selective lens assembly 115 to operate in one of the lensing states to provide an optical power of P to the p-polarized input beam 161, and output a p-polarized beam 163 propagating toward the polarization selective steering assembly 110. The polarization selective lens assembly 115 may focus (or converge) or defocus (or diverge) the p-polarized input beam 161, depending on a sign (e.g., positive or negative) of the optical power P. The third waveplate (e.g., QWP) 142b may be configured to convert the s-polarized beam 163 into a circularly polarized beam. For discussion purposes, FIG. 1C shows that the third waveplate 142b may convert the s-polarized beam 163 into an LHCP beam 165 propagating toward the second waveplate 144.

The controller 120 may be configured to control the second waveplate 144 to operate in the non-switching state to maintain the polarization of the LHCP beam 165, or operate in the switching state to convert the LHCP beam 165 into an RHCP beam. For discussion purposes, FIG. 1C shows that the controller 120 may be configured to control the second waveplate 144 to operate in the switching state to convert the LHCP beam 165 into an RHCP beam 167 propagating toward the polarization selective steering assembly 140. The controller 120 may be configured to control the polarization selective steering assembly 140 to operate in one of the steering states to forwardly steer the RHCP beam 167, e.g., counter-clockwise (e.g., with a steering angle of a) with respect to an initial optical path of the beam 167. The polarization selective steering assembly 140 may output a circularly polarized beam having a handedness that is the same as or opposite to the handedness of the RHCP beam 167. For discussion purposes, FIG. 1C shows that the polarization selective steering assembly 140 may be configured to output an LHCP beam 169 having a handedness that is opposite to the handedness of the RHCP beam 167. The LHCP beam 169 may propagate toward the first waveplate (e.g., QWP) 142a. The first waveplate (e.g., QWP) 142a may be configured to convert the LHCP beam 169 into a linearly polarized beam. For discussion purposes, FIG. 1B shows the first waveplate (e.g., QWP) 142a may be configured to convert the LHCP beam 169 into a p-polarized beam 171 propagating toward the reflector 105.

The reflector 105 may be configured to substantially maintain the polarization of the p-polarized beam 171 when reflecting (e.g., backwardly diffracting) the p-polarized beam 171 as a p-polarized beam 173 propagating toward the first waveplate 142a. The first waveplate (e.g., QWP) 142a may be configured to convert the p-polarized beam 173 into an RHCP beam 175 propagating toward the polarization selective steering assembly 140. That is, a stack of the first waveplate (e.g., QWP) 142a and the reflector 105 may be configured to convert the LHCP beam 169 output from the polarization selective steering assembly 140 into a circularly polarized beam with an orthogonal polarization (e.g., RHCP beam 175), after the LHCP beam 169 is transmitted through the first waveplate (e.g., QWP) 142a for the first time, reflected (e.g., backwardly diffracted) by the reflector 105 back to the first waveplate (e.g., QWP) 142a, and transmitted through the first waveplate (e.g., QWP) 142a for the second time toward the polarization selective steering assembly 140. Thus, the polarized input beam 161 incident ono the polarization selective steering assembly 140 for the first time (e.g., as the beam 167) and the second time (e.g., as the beam 175) may have the same polarization, e.g., the right-handed circular polarization. That is, the beams incident onto the polarization selective steering assembly 140 from different (e.g., opposite) sides of the polarization selective steering assembly 140 may have the same polarization. The polarization selective steering assembly 140 operating in the one of the steering states may forwardly steer the RHCP beam 175 clockwise (e.g., with a steering angle of a) with respect to the initial optical path of the input beam 175, and output an LHCP beam 177 having a handedness that is opposite to the handedness of the RHCP beam 175.

The second waveplate (e.g., SHWP) 144 operating in the switching state may convert the LHCP beam 177 into an RHCP beam 179 propagating toward the third waveplate 142b. The third waveplate (e.g., QWP) 142b may be configured to convert the RHCP beam 179 into an s-polarized beam 181 propagating toward the polarization selective lens assembly 115. Thus, the polarized input beam 161 incident ono the polarization selective lens assembly 115 for the first time (e.g., as the beam 161) and the second time (e.g., as the beam 181) may have the same polarization, e.g., the s-polarization. The polarization selective lens assembly 115 operating in the one of the lensing states may be configured to provide the optical power of P to the s-polarized beam 181, and output a p-polarized beam 183 that is focused to a spot O at the image plane 117.

For discussion purposes, in the embodiment shown in FIG. 1C, the polarization selective lens assembly 115 operating in the one of the lensing states is presumed to provide a negative optical power to an s-polarized beam. Thus, the polarization selective lens assembly 115 may defocus (or diverge) the s-polarized input beam 161 for the first time as the s-polarized beam 161 and for the second time as the s-polarized beam 181. In other words, the polarization selective lens assembly 115 may provide a defocusing effect to the s-polarized input beam 161. Thus, the beam steering device 160 may steer and focus the s-polarized input beam 161 to the spot O at the image plane 117 having the image distance d greater than the predetermined image distance d′.

FIG. 1D schematically illustrates a diagram of a beam steering device 190 configured to provide a 3D beam steering, according to another embodiment of the present disclosure. The beam steering device 190 may include elements similar to or the same as those included in the beam steering device 100 shown in FIG. 1A, the beam steering device 130 shown in FIG. 1B, or the beam steering device 160 shown in FIG. 1C. Descriptions of the same or similar elements can refer to the above descriptions rendered in connection with FIG. 1A, FIG. 1B, or FIG. 1C. As shown in FIG. 1D, the beam steering device 190 may include the reflector 105, the polarization selective steering assembly 110, the first waveplate 142, the second waveplate 144, and the polarization selective lens assembly 145 arranged in an optical series (e.g., in a stack). In some embodiments, the polarization selective steering assembly 110 may be disposed between the reflector 105 and the first waveplate 142. The first waveplate 142 may be disposed between the polarization selective steering assembly 110 and the second waveplate 144. The second waveplate 144 may be disposed between the first waveplate 142 and the polarization selective lens assembly 145.

In the embodiment shown in FIG. 1D, the polarization selective lens assembly 145 may be circular polarization selective, and the polarization selective steering assembly 110 may be linear polarization selective. That is, the polarization selective lens assembly 145 and the polarization selective steering assembly 110 may have different types of polarization selectivities. The second waveplate 144 may function as an SHWP for a beam having a wavelength within a predetermined wavelength range and an incidence angle within a predetermined incidence angle range. In some embodiments, the second waveplate 144 functioning as an SHWP may be included in the polarization selective lens assembly 145. The first waveplate 142 function as a QWP for an input beam having a wavelength within a predetermined wavelength range and an incidence angle within a predetermined incidence angle range. In some embodiments, the first waveplate 142 may be included in the polarization selective steering assembly 110 or the polarization selective lens assembly 145. Descriptions of the reflector 105, the polarization selective steering assembly 110, the first waveplate 142, the second waveplate 144, and the polarization selective lens assembly 145 can refer to the above descriptions rendered in connection with FIGS. 1A and 1C.

For discussion purposes, in the embodiment shown in FIG. 1D, an input beam 191 of the beam steering device 190 is shown as an RHCP beam. In FIG. 1D, the character “p” denotes that the corresponding beam is a p-polarized beam, the character “R” denotes that the corresponding beam is an RHCP beam, and the character “L” denotes that the corresponding beam is an LHCP beam. The RHCP beam 191 may be first incident onto the polarization selective lens assembly 145. The controller 120 may be configured to control the polarization selective lens assembly 145 to operate in one of the lensing states to provide an optical power of P to the RHCP beam 191. The polarization selective lens assembly 145 may focus (or converge) or defocus (or diverge) the RHCP beam 191, depending on a sign (e.g., positive or negative) of the optical power P. In addition, the polarization selective lens assembly 145 may output a circularly polarized beam having a handedness that is the same as or opposite to the handedness of the RHCP beam 191. For discussion purposes, FIG. 1D shows that the polarization selective lens assembly 145 may provide a negative optical power to defocus (or diverge) the RHCP beam 191, and output an LHCP beam 192 having a handedness that is opposite to the handedness of the RHCP beam 191. The LHCP beam 192 may propagate toward the second waveplate (e.g., SHWP) 144.

The controller 120 may be configured to control the second waveplate (e.g., SHWP) 144 to operate in the non-switching state to maintain the polarization of the LHCP beam 192, or operate in the switching state to switch the LHCP beam 192 to an RHCP beam. For discussion purposes, in the embodiment shown in FIG. 1D, the controller 120 is configured to control the second waveplate (e.g., SHWP) 144 to operate in the switching state to convert the LHCP beam 192 into an RHCP beam 193 propagating toward the first waveplate (e.g., QWP) 142. The first waveplate (e.g., QWP) 142 may be configured to convert the RHCP beam 193 into a linearly polarized beam, e.g., a p-polarized beam 194 propagating toward the polarization selective steering assembly 110.

The controller 120 may be configured to control the polarization selective steering assembly 110 to operate in one of the steering states to forwardly steer the p-polarized beam 194, e.g., counter-clockwise (e.g., with a steering angle of a) with respect to an initial optical path of the beam 194, as a p-polarized beam 195 propagating toward the reflector 105. The reflector 105 may be configured to substantially maintain the polarization of the p-polarized beam 195 when reflecting (e.g., backwardly diffracting) the p-polarized beam 195 as a p-polarized beam 196 propagating toward the polarization selective steering assembly 110. Thus, the input beam 191 incident ono the polarization selective steering assembly 110 for the first time (e.g., as the beam 194) and the second time (e.g., as the beam 196) may have the same polarization, e.g., the p-polarization. That is, the beams incident onto the polarization selective steering assembly 110 from different (e.g., opposite) sides of the polarization selective steering assembly 110 may have the same polarization. The polarization selective steering assembly 110 operating in the one of the steering states may be configured to forwardly steer the p-polarized beam 196 clockwise (e.g., with a steering angle of a) with respect to the initial optical path of the beam 196 as a p-polarized beam 197 propagating toward the first waveplate (e.g., QWP) 142. The first waveplate (e.g., QWP) 142 may be configured to convert the p-polarized beam 197 into an LHCP beam 198 propagating toward the second waveplate (e.g., SHWP) 144.

The second waveplate (e.g., SHWP) 144 operating in the switching state may convert the LHCP beam 198 into an RHCP beam 199 propagating toward the polarization selective lens assembly 145. Thus, the input beam 191 incident ono the polarization selective lens assembly 145 for the first time (e.g., as the beam 191) and the second time (e.g., as the beam 199) may have the same polarization, e.g., the right-handed circular polarization. That is, the beams incident onto the polarization selective lens assembly 145 from different (e.g., opposite) sides of the polarization selective lens assembly 145 may have the same polarization. The polarization selective lens assembly 145 operating in the one of the lensing states may be configured to provide the optical power of P to the RHCP beam 199, and output an LHCP beam 189 that may be focused to a spot O at the image plane 117.

For discussion purposes, in the embodiment shown in FIG. 1D, the polarization selective lens assembly 145 operating in the one of the lensing states is configured to provide a negative optical power to an RHCP beam. Thus, the polarization selective lens assembly 145 may defocus (or diverge) the RHCP input beam 191 when the RHCP input beam 191 is incident onto the polarization selective lens assembly 145 for the first time (e.g., as the RHCP beam 191) and the second time (e.g., as the RHCP beam 199). In other words, the polarization selective lens assembly 145 may provide a defocusing effect to the RHCP input beam 191. The beam steering device 190 may steer and focus the RHCP input beam 191 to the spot O at the image plane 117 having the image distance d greater than the predetermined image distance d′.

Referring to FIGS. 1A-1D, the reflector 105 may be implemented in combination with other optical elements, such that the input beam 101, 131, 161, or 191 incident onto the polarization selective lens assembly 115 or 145 for the first time and the second time may have the same polarization. In some embodiments, the input beam 101, 131, 161, or 191 incident onto the polarization selective steering assembly 110 or 140 for the first time and the second time may have the same polarization. Thus, a focusing/defocusing effect provided by the polarization selective lens assembly 115 or 145 for the input beam 101, 131, 161, or 191 may be enhanced (e.g., doubled) after the input beam 101, 131, 161, or 191 propagates through the polarization selective lens assembly 115 or 145 for two times. Similarly, a steering effect provided by the polarization selective steering assembly 110 or 140 for the input beam 101, 131, 161, or 191 may be enhanced after the input beam 101, 131, 161, or 191 propagates through the polarization selective steering assembly 110 or 140 for two times. For example, the steering angle may be increased (e.g., doubled) as compared to a conventional configuration in which the input beam propagates through the polarization selective steering assembly 110 or 140 for one time. Compared to a conventional beam steering device, the polarization selective steering assembly 110 or 140 may provide an enhanced steering effect without increasing the thickness (or with a substantially smaller thickness), and the polarization selective lens assembly 115 or 145 may provide an enhanced focusing/defocusing effect without increasing the thickness (or with a substantially smaller thickness). Thus, the beam steering device 100, 130, 160, or 190 may provide a 3D beam steering with a substantially smaller weight and form factor.

Although not shown, in some embodiments, the controller 120 may be configured to control the polarization selective lens assembly 115 or 145 to operate in a lensing state to focus (or converge) the input beam 101, 131, 161, or 191. That is, the image distanced of the image plane 117 at which input beam 101, 131, 161, or 191 is focused by the beam steering device 100 may be smaller than the predetermined image distance d′. In other words, the polarization selective lens assembly 115 or 145 operating in the lensing state may provide a focusing effect to the input beam 101, 131, 161, or 191. Thus, the beam steering device 100, 130, 160, or 190 may steer and focus the input beam 101, 131, 161, or 191 to one or more spots O at the image plane 117 having the image distance d smaller than the predetermined image distance d′. In some embodiments, the controller 120 may control the polarization selective lens assembly 115 or 145 to operate in a natural state to provide a substantially zero optical power to the input beam 101, 131, 161, or 191. In such an embodiment, the polarization selective lens assembly 115 or 145 may not focus (or converge) or defocus (or diverge) the input beam 101, 131, 161, or 191. Thus, the beam steering device 100, 130, 160, or 190 may focus the input beam 101, 131, 161, or 191 to one or more spots at the predetermined image plane 117′.

In some embodiments, the reflector 105 may include an HOE that has a wide field of view (“FOV”). In some embodiments, the HOE may include a fixed hologram. In some embodiments, the HOE may include a volume (or Bragg) hologram configured to function over a narrow set of angles and wavelengths. In some embodiments, the HOE may be multiplexed to have high diffraction efficiencies at a plurality of wavelengths, (e.g., red, green, and blue wavelengths). In some embodiments, the HOE may be angularly selective to an input beam and may be multiplexed with a plurality of holograms, such that the optical prescription of the HOE may change as a function of an incidence angle of the input beam. In some embodiments, the multiplexed holograms may be angularly selective to the incidence angle corresponding to the steering states of the polarization selective steering assembly 110 or 140 and the lensing state of the polarization selective lens assembly 115 or 145. In some embodiments, the optical prescriptions for respective multiplexed holograms may be designed to correct optical aberrations (e.g. pupil aberrations) for respective steering states of the polarization selective steering assembly 110 or 140 and respective lensing states of the polarization selective lens assembly 115 or 145.

It is noted that the order in which various elements are arranged in the embodiments shown in FIGS. 1A-1D is for illustrative purposes. The elements may be arranged in other suitable orders. For example, the positions of the polarization selective steering assembly 110 and the polarization selective lens assembly 115 shown in FIG. 1A may be switched. In some embodiments, in FIG. 1B, the positions of the polarization selective steering assembly 140 and the polarization selective lens assembly 145 may be switched. In some embodiments, in FIG. 1C, the positions of the polarization selective steering assembly 140 and the polarization selective lens assembly 115 may be switched, the first waveplate 142a may be omitted, and the positions of the second waveplate 144 and the third waveplate 142b may be switched. In some embodiments, in FIG. 1D, the positions of the polarization selective steering assembly 110 and the polarization selective lens assembly 145 may be switched, the first waveplate 142a may be omitted, and the positions of the second waveplate 144 and the third waveplate 142b may be switched, the positions of the second waveplate 144 and the first waveplate 142 may be switched, and the beam steering device may further include another waveplate (e.g., a third waveplate function as a QWP) disposed between the polarization selective lens assembly 145 and the reflector 105.

For illustrative and discussion purposes, FIGS. 1A-1D show after the input beam 101, 131, 161, or 191 propagates through the polarization selective steering assembly 110 or 140 for two times, the beam 101, 131, 161, or 191 may be steered for two times toward the left side of the surface normal by the polarization selective steering assembly 110 or 140. Although not shown, in some embodiments, after the input beam 101, 131, 161, or 191 propagates through the polarization selective steering assembly 110 or 140 for two times, the beam 101 may be steered toward the right side of the surface normal by the polarization selective steering assembly 110 for two times. Thus, the steering effect provided by the polarization selective steering assembly 110 or 140 to the input beam 101, 131, 161, or 191 may be enhanced.

FIG. 2 schematically illustrates a diagram of a polarization selective steering assembly 200, according to an embodiment of the present disclosure. The polarization selective steering assembly 200 may be circular polarization selective. The polarization selective steering assembly 200 may be an embodiment of the polarization selective steering assembly 140 included in the beam steering device 130 shown in FIG. 1B or the beam steering device 160 shown in FIG. 1C. As shown in FIG. 2, the polarization selective steering assembly 200 may include a plurality of polarization selective steering elements 220 and a plurality of SHWP 210 alternately arranged in a stack. The polarization selective steering element 220 may be circular polarization selective. In some embodiments, the polarization selective steering element 220 may be a PBP LC grating 220, which may modulate a circularly polarized beam based on a phase profile provided through a geometric phase. The polarization selective steering assembly 200 may also be referred to as a PBP grating assembly 200. For illustrative purposes, FIG. 2 shows that the PBP grating assembly 200 may include five SHWPs 210 that are labelled SHWP1 to SHWP5, and four PBP LC gratings 220 that are labelled PBP1 to PBP4. The elements shown in FIG. 2 will be described in detail later.

FIG. 3A schematically illustrates an x-y sectional view of in-plane orientations of LC molecules included in a PBP LC grating 300, according to an embodiment of the present disclosure. The PBP LC grating 300 may be an embodiment of the PBP LC gratings 220 shown in FIG. 2. FIG. 3B schematically illustrates a y-z sectional view of out-of-plane orientations of LC molecules included in the PBP LC grating 300 shown in FIG. 3A, according to an embodiment of the present disclosure. FIGS. 3C and 3D illustrate polarization selective diffractions of the PBP LC grating 300 shown in FIGS. 3A and 3B, according to an embodiment of the present disclosure. The PBP LC grating 300 may include an LC film 305. As shown in FIGS. 3A and 3B, the LC film 305 may include a first surface 305-1 and a second surface 305-2 opposite to the first surface 305-1 in the thickness direction (e.g., the z-axis direction). In a region substantially close to (including at) a surface (e.g., at least one of the first surface 305-1 or the second surface 305-2) of the LC film 305, the optic axis of the LC film 305 may rotate continuously and periodically in a predetermined in-plane direction (e.g., a y-axis direction) with a uniform (or same) in-plane pitch Λy.

As shown in FIG. 3A, in a region substantially close to (including at) a surface (e.g., at least one of the first surface 305-1 or the second surface 305-2) of the LC film 305, the LC molecules 312 may have a periodic in-plane orientation pattern with a uniform (e.g., same) in-plane pitch Λy in a predetermined in-plane direction (e.g., a y-axis direction). For example, LC directors of LC molecules 312 located in close proximity to or at a surface (e.g., at least one of the first surface 305-1 or the second surface 305-2) of the LC film 305 may be arranged in different orientations. The orientations of the LC directors of the LC molecules 312 distributed along the predetermined in-plane direction in the surface (or in a plane parallel with the surface) may exhibit a periodic and continuous rotation. In other words, azimuthal angels ϕ of the LC molecules 312 located in close proximity to or at the surface of the LC film 305 and distributed along the predetermined in-plane direction in the surface may be configured to exhibit a periodic and continuous change. In addition, at the surface of the LC film 305, the directors of the LC molecules 312 may rotate in a predetermined rotation direction, e.g., a clockwise direction or a counter-clockwise direction. Accordingly, the rotation of the directors of the LC molecules 312 at the surface of the LC film 305 may exhibit a handedness, e.g., right handedness or left handedness.

The predetermined in-plane direction may be any suitable in-plane direction along the surface (or in a plane parallel with the surface) of the LC film 305. For illustrative purposes, FIG. 3A shows that the predetermined in-plane direction is a y-axis direction. The in-plane pitch Λy is defined as a distance along the in-plane direction (e.g., the y-axis direction) over which the orientations of the LC directors change by a predetermined value (e.g., 180°) from a predetermined initial orientation (or reference orientation). The in-plane pitch Λy may determine, in part, the optical properties of the PBP LC grating 300. For example, the in-plane pitch Λy may determine the diffraction angles of the diffracted beam in the different diffraction orders. In some embodiments, the diffraction angle for a given wavelength of beam may increase as the in-plane pitch Λy decreases.

FIG. 3B schematically illustrates a y-z sectional view of a portion of out-of-plane orientations of the directors of the LC molecules 312 in the LC film 305 of the PBP LC grating 300. In the embodiment shown in FIG. 3B, within a volume of the LC film 305, along the thickness direction (e.g., the z-axis direction) of the LC film 305, the orientations of the directors (or the azimuth angles ϕ) of the LC molecules 312 may remain substantially the same from the first surface 305-1 to the second surface 305-2 of the LC film 305. In some embodiments, the thickness of the LC film 305 may be configured as d=λ/(2*An), where λ is a design wavelength, Δn is the birefringence of the LC material of the LC film 305, and Δn=n_{c}−n₀, n_{c} and n₀ are the extraordinary and ordinary refractive indices of the LC material, respectively. In some embodiments, a twist structure may be introduced along the thickness direction of the LC film 305 and compensated for by its mirror twist structure, which may enable the PBP LC grating to have an achromatic performance.

FIGS. 3C and 3D illustrate polarization selective diffractions of the PBP LC grating 300 shown in FIGS. 3A and 3B. The PBP LC grating 300 may be a passive PBP LC grating or an active PBP LC grating. A passive PBP LC grating may have or may be configurable to operate in one of two optical states, a positive state or a negative state. Referring to FIGS. 3C and 3D, the optical state of the passive PBP LC grating may depend on the handedness of a circularly polarized input beam and the handedness of the rotation of the directors of the LC molecules 312 at the surface (e.g., at least one of the first surface 305-1 or the second surface 305-2) of the LC film 305. For example, as shown in FIG. 3C, the passive PBP LC grating may operate in a positive state in response to an RHCP beam 330 having a wavelength within a predetermined wavelength range and an incidence angle within a predetermined incidence range. The passive PBP LC grating may forwardly diffract the RHCP beam 330 to a negative angle (e.g., −θ). As shown in FIG. 3D, the passive PBP LC grating may operate in a negative state in response to an LHCP beam 335 having a wavelength within a predetermined wavelength range and an incidence angle within a predetermined incidence range. The passive PBP LC grating may forwardly diffract the LHCP beam 335 to a positive angle (e.g., +θ). In addition, the passive PBP LC grating may reverse the handedness of a circularly polarized beam transmitted through the passive PBP LC grating in addition to diffracting the beam. For example, as shown in FIG. 3A, the passive PBP LC grating may forwardly diffract the RHCP beam 330 as an LHCP beam 340. As shown in FIG. 3B, the passive PBP LC grating may forwardly diffract the LHCP beam 335 as an RHCP beam 345. In some embodiments, the passive PBP LC grating may operate in a positive state in response to an LHCP beam, and operate in a negative state in response to an RHCP beam. The passive PBP LC grating may be indirectly switchable between a positive state and a negative state via changing a handedness of a circularly polarized input beam through an external polarization switch (e.g., an SHWP) coupled to the passive PBP LC grating.

An active PBP LC grating may have or may be configurable to operate in one of three optical states, a positive state, a neutral state, or a negative state. The optical state of the active PBP LC grating may depend on the handedness of a circularly polarized input beam, the handedness of the rotation of the directors of the LC molecules 312 at the surface of the LC film 305, and a voltage applied to the active PBP LC grating. For example, as shown in FIG. 3C, when a voltage applied to the active PBP LC grating (via a power source controlled by a controller, not shown in FIG. 3C) is smaller than a predetermined threshold voltage, the active PBP LC grating may operate in a positive state in response to an RHCP beam 330 having a wavelength within a predetermined wavelength range and an incidence angle within a predetermined incidence range. The active PBP LC grating may forwardly diffract the RHCP beam 330 to a negative angle (e.g., −θ). As shown in FIG. 3D, when a voltage applied to the active PBP LC grating (via a power source controlled by a controller, not shown in FIG. 3D) is smaller than a predetermined threshold voltage, the active PBP LC grating may operate in a positive state in response to an LHCP beam 335 having a wavelength within a predetermined wavelength range and an incidence angle within a predetermined incidence range. The active PBP LC grating may forwardly diffract the LHCP beam 335 to a positive angle (e.g., +θ). In addition, similar to the passive PBP LC grating, the active PBP LC grating operating in the positive state or the negative state may reverse the handedness of a circularly polarized beam transmitted while diffracting the circularly polarized beam.

The active PBP LC grating may operate in a neutral state when the voltage applied to the active PBP LC grating is sufficient high to reorient the LC molecules along the direction of a generated electric field. The active PBP LC grating operating in a neutral state may not diffract a circularly polarized beam, and may or may not affect the polarization of a circularly polarized beam transmitted therethrough. For example, in some embodiments, the electric field generated in the LC film 305 may be a vertical electric field, and the active PBP LC grating operating in a neutral state may not affect the polarization of a circularly polarized beam transmitted therethrough. In some embodiments, the electric field generated in the LC film 305 may be a horizontal electric field, and the active PBP LC grating operating in a neutral state may reserve the handedness of a circularly polarized beam transmitted therethrough. The active PBP LC grating may be indirectly switchable between a positive state and a negative state when a handedness of an input beam is changed through an external polarization switch (e.g., an SHWP) coupled to the active PBP LC grating. In addition, the active PBP LC grating may be directly switchable between a positive state (or negative state) and a neutral state when an applied voltage is changed.

Referring back to FIG. 2, the SHWP 210 disposed before a corresponding PBP LC grating 220 may be configured to control the handedness of a circularly polarized beam before the beam is incident onto the PBP LC grating 220. The SHWP 210 may be configured to operate in a suitable operating state (e.g., a switching state or a non-switching state). Thus, the SHWP 210 disposed before the PBP LC grating 220 may control the operation state (e.g., positive state or negative state) of the PBP LC grating 220. In some embodiments, when the PBP LC grating 220 is an active PBP LC grating, through controlling the voltage applied to the PBP LC grating 220, the PBP LC grating 220 may operate in a neutral state. Thus, through controlling the operation states of the SHWPs 210 (and controlling the voltage applied to the PBP LC grating 220 when the PBP LC grating 220 are active PBP LC gratings), the steering state of the PBP grating assembly 200 may be changed. Accordingly, the steering angle of a circularly polarized input beam output from the PBP grating assembly 200 may be changed. For example, as shown in FIG. 2, the PBP grating assembly 200 may be a 4-stage PBP grating assembly including four PBP LC gratings 220 (e.g., PBP 1 to PBP4) and four SHWPs 210 (e.g., SHWP1 to SHWP4) alternately arranged in a stack. The PBP grating assembly 200 may provide a total number of sixteen steering states, which may result in sixteen steering angles. When steering angles of the PBP LC gratings PBP1 to PBP4 are configured to be about ±1°, ±2°, ±4° and ±8°, respectively, the maximum steering angle provided by the PBP grating assembly 200 may be about ±15°.

FIG. 2 also shows polarization tracks of a steering state of the PBP grating assembly 200 for providing a −15° steering angle for a normally incident RHCP beam 202. For illustrative purposes, FIG. 2 shows that the PBP LC gratings PBP 1 to PBP4 are left-handed passive PBP LC gratings configured to operate in a positive state to diffract an LHCP beam to a positive angle and operate in a negative state to diffract an RHCP beam to a negative angle. A controller (e.g., the controller 120 shown in FIGS. 1A-1D) may be configured to control the SHWP1 to operate in a non-switching state. Thus, the SHWP1 may transmit the RHCP beam 202 as an RHCP beam 212 propagating toward the PBP LC grating PBP1. The PBP LC grating PBP1 may operate in the negative state for the RHCP beam 212 to diffract the RHCP beam 212 by about −1°. In addition, the PBP LC grating PBP1 may reverse the handedness of the RHCP beam 212 and output an LHCP beam 222. The controller (e.g., the controller 120 shown in FIGS. 1A-1D) may be configured to control the SHWP2 to operate in a switching state. Thus, the SHWP2 may transmit the LHCP beam 222 as an RHCP beam 232 propagating toward the PBP LC grating PBP2. The PBP LC grating PBP2 may be controlled by the controller to operate in the negative state for the RHCP beam 232, and may diffract the RHCP beam 232 by about −2°. The PBP LC grating PBP2 may output an LHCP beam 242. The controller may control both the SHWP3 and the SHWP4 to operate in a switching state. Thus, the PBP LC grating PBP3 may operate in the negative state for an RHCP beam 252, and may diffract the RHCP beam 252 by about −4° as an LHCP beam 262. The PBP LC grating PBP4 may operate in the negative state for an RHCP beam 272, and may diffract the RHCP beam 272 by about −8° as an LHCP beam 282. Thus, the PBP grating assembly 200 may be configured to steer the input RHCP beam 205 by about −15° ((−1°+)(−2°+)(−4°+)(−8°=−15°), resulting a steering angle θ of about −15°.

In some embodiments, the PBP grating assembly 200 may further include a circular polarizer 240 disposed after the PBP LC grating PBP4. The circular polarizer 240 may be configured to reduce or eliminate a light leakage caused by undesirable diffraction orders having a handedness that is opposite to a handedness of desirable diffraction orders. For example, a desirable diffraction order of the PBP grating assembly 200 may be an LHCP beam, and an undesirable diffraction order of the PBP grating assembly 200 may be an RHCP beam. In some embodiments, the circular polarizer 240 may be configured to be a left-handed circular polarizer to substantially transmit an LHCP beam and substantially block an RHCP beam via absorption. For example, as shown in FIG. 2, the circular polarizer 240 may substantially transmit the LHCP beam 282 (e.g., desirable diffraction orders) output from the PBP LC grating PBP4 as an LHCP beam 292, and substantially block an RHCP beam (e.g., undesirable diffraction orders, not shown in FIG. 2) output from the PBP LC grating PBP4 (the RHCP beam is not shown). In some embodiments, the PBP grating assembly 200 may further include an SHWP5. The circular polarizer 240 may be disposed between the PBP LC grating PBP4 and the SHWP5. The controller may be configured to control the SHWP5 to operate in a switching state to convert the LHCP beam 292 output from the circular polarizer 240 into an RHCP beam, or operate in a non-switching state to maintain a polarization of the LHCP beam 292. That is, the beam 294 may be an RHCP beam or an LHCP beam. Thus, the PBP grating assembly 200 may be configured to output the circularly polarized beam 294 having a desirable handedness (e.g., an RHCP beam or an LHCP beam) and a desirable steering angle.

In some embodiments, the PBP LC gratings 220 included in the PBP grating assembly 200 may have the same polarization selectivity. For example, the PBP LC gratings 220 may be right-handed or left-handed PBP LC gratings. In some embodiments, the PBP LC gratings 220 included in the PBP grating assembly 200 may have different polarization selectivities. For example, the PBP grating assembly 200 may include both a right-handed PBP LC grating and a left-handed PBP LC grating. In some embodiments, the PBP LC gratings 220 included in the PBP grating assembly 200 may be passive or active PBP LC gratings. In some embodiments, the PBP grating assembly 200 may include both a passive PBP LC grating and an active PBP LC grating. In some embodiments, the PBP LC gratings 220 included in the PBP grating assembly 200 may have a substantially same in-plane pitch or different in-plane pitches. In some embodiments, the combination of SHWP1 to SHWP4 and PBP1 to PBP 4 may be referred to as a first set of PBP LC gratings configured to steer a circularly polarized input beam along a first axis (e.g., a y-axis direction), and the PBP grating assembly 200 may include a second set of PBP LC gratings configured to steer a circularly polarized input beam along a second axis (e.g., an x-axis direction). Thus, the PBP grating assembly 200 may be configured to steer a circularly polarized input beam along two different axes (e.g., along the x-axis direction and the y-axis direction).

FIG. 4 schematically illustrates a diagram of a polarization selective lens assembly 400, according to an embodiment of the present disclosure. The polarization selective lens assembly 400 may be circular polarization selective. The polarization selective lens assembly 400 may be an embodiment of the polarization selective lens assembly 145 included in the beam steering device 130 shown in FIG. 1B or the beam steering device 190 shown in FIG. 1D. As shown in FIG. 4, the polarization selective lens assembly 400 may include a plurality of polarization selective lenses 420 and a plurality of SHWP 410 alternately arranged in an optical series (e.g., in a stack). The polarization selective lens 420 may be circular polarization selective. For example, the polarization selective lens 420 may be a PBP LC lens 420 configured to modulate a circularly polarized beam based on a phase profile provided through a geometric phase. The polarization selective lens assembly 400 may also be referred to as a PBP LC lens assembly 400. For illustrative purposes, FIG. 4 shows that the PBP LC lens assembly 400 includes three SHWPs 410 (e.g., labelled as SHWP1 to SHWP3) and three PBP LC lenses 420 (e.g., labelled as PBP1 to PBP3) alternately arranged in a stack.

FIG. 5A schematically illustrates an x-y sectional view of in-plane orientations of LC molecules in an LC film 505 included in a PBP LC lens 500, according to an embodiment of the present disclosure. FIG. 5B illustrates a section of the in-plane orientation pattern taken along a y-axis in the LC film 505 of the PBP LC lens 500 shown in FIG. 5A, according to an embodiment of the present disclosure. The PBP LC lens 500 may be an embodiment of the PBP LC lens 420 shown in FIG. 4. The LC film 505 may include a first surface and a second surface opposite to the first surface. In a region substantially close to (including at) a surface (e.g., at least one of the first surface or the second surface) of the LC film 505, orientations of the optic axis of the LC film 505 may exhibit a continuous rotation along at least two opposite in-plane directions from a lens center to opposite lens peripheries. In some embodiments, the continuous rotation may have a varying pitch. In some embodiments the PBP LC lens 500 may function as a polarization selective lens.

As shown in FIG. 5A, the LC molecules 512 located in close proximity to or at a surface (e.g., at least one of the first surface or the second surface) of the LC film 505 may be configured with an in-plane orientation pattern having a varying pitch along at least two opposite in-plane directions from a lens center 510 to opposite lens peripheries 515. In other words, orientations of the LC directors of LC molecules 512 located in close proximity to or at the surface of the LC film 505 may exhibit a continuous rotation with a varying pitch along at least two opposite in-plane directions from the lens center 510 to the opposite lens peripheries 515. The LC directors may rotate in a same rotation direction (e.g., clockwise, or counter-clockwise), and the angles of rotation may change from the lens center 510 to the opposite lens peripheries 515. A pitch A of the in-plane orientation pattern may be defined as a distance along the in-plane direction (e.g., a radial direction) over which the orientation of the LC director (or an azimuthal angle ϕ of the LC molecule 512) changes by a predetermined angle (e.g., 180°) from a predetermined initial state or angle. As shown in FIG. 5B, according to the LC director field along the y-axis direction, the pitch A may be a function of the distance from the lens center 510. The pitch A may monotonically decrease from the lens center 510 to the lens peripheries 515 along the at least two opposite in-plane directions (e.g., two opposite radial directions) in the x-y plane, e.g., Λ₀>Λ₁> . . . >Λᵣ. Λ₀ is the pitch at a central region of the PBP LC lens 500, which may be the largest. The pitch Λᵣ is the pitch at an edge region (e.g., periphery 515) of the PBP LC lens 500, which may be the smallest. In some embodiments, the azimuthal angle ϕ of the LC molecule 512 may change in proportion to the distance from the lens center 510 to a local point of the LC film 505 at which the LC molecule 512 is located. For example, the azimuthal angle ϕ of the LC molecule 512 may change according to an equation of

$$ϕ = \frac{π {r}^{2}}{2 f λ} ,$$

where ϕ is the azimuthal angle of the LC molecule 512 at a local point of the LC film 505, r is a distance from the lens center 510 to the local point in the lens plane, f is a focal distance of the PBP LC lens 500, and λ is a designed operation wavelength of the PBP LC lens 500.

FIGS. 5C and 5D illustrate polarization selective defocusing/focusing of the PBP LC lens 500, according to an embodiment of the present disclosure. The PBP LC lens 500 may be a passive PBP LC lens or an active PBP LC lens. A passive PBP LC lens may be configurable to operate in one of two optical states, i.e., a focusing (or converging) state or a defocusing (or diverging) state. The optical state of the passive PBP LC lens may depend on the handedness of a circularly polarized input light and the rotation direction of the LC directors along the at least two opposite in-plane directions from the lens center 510 to the opposite lens peripheries 515. For example, as shown in FIG. 5C, the passive PBP LC lens may operate in the defocusing state (or the diverging state) for an RHCP light 530 having a wavelength in a predetermined wavelength range and an incidence angle in a predetermined incidence range. As shown in FIG. 5D, the passive PBP LC lens may operate in the focusing state (or the converging state) for an LHCP light 540 having a wavelength in a predetermined wavelength range and an incidence angle in a predetermined incidence range. In addition, the passive PBP LC lens may reverse the handedness of a circularly polarized light transmitted therethrough while focusing/defocusing the light. For example, as shown in FIG. 5C, the passive PBP LC lens may diverge the on-axis collimated RHCP light 530 as an LHCP light 540. As shown in FIG. 5D, the passive PBP LC lens may converge the on-axis collimated LHCP light 535 as an RHCP light 545. The passive PBP LC lens may be indirectly switchable between the positive state and the negative state when a handedness of an input light is changed through an external polarization switch (e.g., an SHWP).

An active PBP LC lens may have, or may be configurable to operate in, three optical states, i.e., a positive state, a neutral state, and a negative state. The active PBP LC lens may include electrodes electrically coupled with a power source. The power source may be controlled by a controller. The optical state of the active PBP LC lens may depend on the handedness of a circularly polarized input light, the rotation direction of the LC directors in the at least two opposite in-plane directions from the lens center 510 to the opposite lens peripheries 515, and a voltage applied to the active PBP LC lens. For example, when a voltage applied to the active PBP LC lens is lower than a predetermined threshold voltage, the active PBP LC lens may operate in the defocusing state (or the diverging state) for the RHCP light 530 (as shown in FIG. 5C) and operate in the focusing state (or the converging state) for the LHCP light 535 (as shown in FIG. 5D). In addition, similar to the passive PBP LC lens, the active PBP LC lens operating in the focusing state or the defocusing state may reverse the handedness of a circularly polarized light transmitted therethrough in addition to diffracting the light.

The active PBP LC lens may operate in a neutral state when the voltage applied to the active PBP LC lens is sufficiently high to re-orient the LC molecules along the direction of a generated electric field. The active PBP LC lens operating in a neutral state may not focus or defocus a circularly polarized light, and may or may not affect the polarization of a circularly polarized light transmitted therethrough. For example, in some embodiments, when the electric field generated in the LC film 505 is a vertical electric field that is sufficiently high, the active PBP LC lens may operate in the neutral state, and may negligibly affect or may not affect the propagation direction, the wavefront, and the handedness of the circularly polarized incident light. In some embodiments, when the electric field generated in the LC film 505 is a horizontal electric field that is sufficiently high, the active PBP LC lens may operate in the neutral state, may negligibly affect or may not affect the propagation direction and the wavefront of the circularly polarized incident light, and may reverse the handedness of the circularly polarized incident light. The active PBP LC lens may be indirectly switchable between a focusing state and a defocusing state when a handedness of an input light is changed through an external polarization switch (e.g., an SHWP). In some embodiments, the active PBP LC lens may be directly switchable between a focusing state (or defocusing state) and a neutral state when the applied voltage is varied.

Referring back to FIG. 4, an SHWP 410 disposed before a corresponding PBP LC lens 420 may be configured to control the handedness of a circularly polarized beam before the beam is incident onto the PBP LC lens 420 in accordance with an operating state (e.g., a switching state or a non-switching state) of the SHWP 410. Thus, the SHWP 410 placed before the PBP LC lens 420 may control the PBP LC lens 420 to operate in a focusing state or a defocusing state. In some embodiments, when the PBP LC lens 420 is an active PBP LC lens, through controlling the voltage applied to the PBP LC lens 420, the PBP LC lens 420 may also operate in a neutral state. An optical power of the PBP LC lens assembly 400 may be a sum of the optical powers of the respective PBP LC lenses 420 included in the PBP LC lens assembly 400. Thus, through controlling the operation states of the SHWPs 410 (and controlling the voltage applied to the PBP LC lenses 420 when the PBP LC lenses 420 are active PBP LC lenses), the lensing state of the PBP LC lens assembly 400 may be changed. Accordingly, the optical power of the PBP LC lens assembly 400 may be changed.

For illustrative purposes, FIG. 4 shows that the PBP LC lenses PBP1 to PBP3 are left-handed passive PBP LC lenses configured to operate in a focusing state for an LHCP beam and operate in a defocusing state for an RHCP beam. As shown in FIG. 4, an RHCP beam 402 may be incident onto the SHWP1. A controller (e.g., the controller 120 shown in FIGS. 1A-1D) may control the SHWP1 to operate in a non-switching state, and the SHWP2 and the SHWP3 to operate in the switching state. Accordingly, the PBP LC lenses PBP1, PBP2, and PBP3 may operate in the defocusing state. The RHCP beam 402 may become a defocused (or divergent) LHCP beam 404 after passing through the PBP LC lenses PBP1, PBP2, and PBP3. In some embodiments, the PBP lens assembly 400 may further include a circular polarizer 440 optically coupled to the PBP LC lens PBP3. The circular polarizer 440 may be configured to reduce or eliminate a light leakage caused by undesirable diffraction orders having a handedness that is opposite to a handedness of desirable diffraction orders. For example, a desirable diffraction order of the PBP lens assembly 400 may be an LHCP beam, and an undesirable diffraction order of the PBP lens assembly 400 may be an RHCP beam. In some embodiments, the circular polarizer 440 may be configured to be a left-handed circular polarizer that substantially transmits an LHCP beam and substantially blocks an RHCP beam via absorption. For example, as shown in FIG. 4, the circular polarizer 440 may substantially transmit the LHCP beam 404 (e.g., desirable diffraction orders) as an LHCP beam 406, and substantially block an LHCP beam (e.g., undesirable diffraction orders, not shown in FIG. 4) output from the PBP LC lens PBP3 via absorption. In some embodiments, the PBP lens assembly 400 may further include an SHWP4. The circular polarizer 440 may be disposed between the PBP LC lens PBP3 and the SHWP4. The controller may control the SHWP4 to operate in a switching state to convert the LHCP beam 406 output from the circular polarizer 440 into an RHCP beam, or in a non-switching state to maintain a polarization of the LHCP beam 406. Thus, the PBP lens assembly 400 may be configured to output a circularly polarized beam 408 having a desirable handedness (e.g., an RHCP beam or an LHCP beam) and a desirable convergence or divergence.

FIG. 6A schematically illustrates a diagram of a polarization selective lens assembly 600, according to an embodiment of the present disclosure. The polarization selective lens assembly 600 may be linear polarization selective. The polarization selective lens assembly 600 may be an embodiment of the polarization selective lens assembly 115 included in the beam steering device 100 shown in FIG. 1A or the beam steering device 160 shown in FIG. 1C. As shown in FIG. 6A, the polarization selective lens assembly 600 may include one or more LC lenses 620 arranged in an optical series (e.g., in a stack). The LC lens 620 may be linear polarization selective. For illustrative purposes, FIG. 6 shows that the polarization selective lens assembly 600 includes three LC lenses 620 (labelled as LC1 to LC3) arranged in an optical series in a stack.

In some embodiments, the LC lens 620 may be configured to utilize the change in a polar angle (or a tilt angle) to create the lens profile. The LC lens 620 may provide an optical power that may be continuously variable. FIGS. 6B and 6C schematically illustrates a diagram of the LC lens 620 included in the polarization selective lens assembly 600 shown in FIG. 6A, according to an embodiment of the present disclosure. FIG. 6B shows the LC lens 620 in a state in which no voltage is applied, or the voltage applied is below or equal to a predetermined threshold voltage. FIG. 6C shows the LC lens 620 in a state when an electric field in which the voltage applied is higher than the predetermined threshold voltage. As shown in FIGS. 6B and 6C, the LC lens 620 may include two substrates 612 and an LC layer 618 disposed between the two substrates 612. The substrates 612 may be substantially transparent in the visible band (about 380 nm to 750 nm). In some embodiments, the substrates 612 may be transparent in some or all of the infrared (“IR”) band (about 750 nm to 1 mm). The substrates 612 may include a transparent material, e.g., SiO₂, plastic, sapphire, etc. Each substrate 612 may be provided with an alignment layer 616 and a conductive electrode 614 (e.g., indium tin oxide (“ITO”)). The LC layer 618 may be in contact with the two alignment layers 616. In some embodiments, the two alignment layers 616 may be configured to provide anti-parallel alignments (indicated by arrows 622 and 622′) to LC molecules 621 in the LC layer 618. In some embodiments, one of the two electrodes 614 may be a planar electrode, and the other one may be a ring-shaped electrode. The substrate 612 may have a first surface facing the LC layer 618 and a second surface opposite to the first surface. In some embodiments, one of the two electrodes 614 (e.g., a planar electrode) may be disposed at the first surface of one substrate 612 (e.g., a left substrate in FIG. 6B), and the other one of the two electrodes 614 (e.g., a ring-shaped electrode) may be disposed at the second surface of the other substrate 612 (e.g., a right substrate in FIG. 6B). When a voltage that is higher than a predetermined threshold voltage is applied to the LC lens 620, as shown in FIG. 6C, due to the ring-shaped electrode 614 disposed on one of the substrates 612, a non-uniform electrode field may be generated in the LC layer 618. For example, the electrical field generated in the LC layer 618 may gradually increase from the center to both edges of the LC layer 618 (or the LC lens 620). Thus, as shown in FIG. 6C, from the center to both edges of the LC layer 618 (or the LC lens 620), the orientations of LC directors 624 may change from being parallel to a surface of the substrate 612 to being closer to perpendicular to the surface of the substrate 612. For a linearly polarized input beam that is polarized in a y-axis direction (e.g., a p-polarized input beam), the effective refractive index of the LC layer 618 may gradually change (e.g., decrease) from the center to both edges of the LC layer 618. The LC layer 618 may provide a positive lens profile for the linearly polarized input beam polarized in the y-axis direction. In other words, when a sufficiently high is applied to the LC lens 620, the LC lens 620 may provide a positive optical power to a linearly polarized input beam that is polarized in the y-axis direction. In some embodiments, as the voltage applied to the LC lens 620 is continuously varied, the lens profile of the LC lens 620 may be continuously adjusted. Thus, the LC lens 620 may provide a continuous adjustment of the optical power within an optical power range to a linearly polarized input beam that is polarized in the y-axis direction (e.g., a p-polarized input beam). In the embodiment shown in FIGS. 6B and 6C, the LC lens 620 may function as a substantially optically uniform plate to a linearly polarized input beam polarized in an x-axis direction (e.g. an s-polarized input beam).

FIGS. 6D and 6E schematically illustrates a diagram of the LC lens 620 included in the polarization selective lens assembly 600 shown in FIG. 6A, according to various embodiments of the present disclosure. In the embodiments shown in FIGS. 6D and 6E, the LC lens 620 may be a refractive Fresnel LC lens having a segmented parabolic profile. Such a refractive Fresnel LC lens may be referred to as a segmented phase profile (“SPP”) LC lens (also referred to as 620 for discussion purposes). The size of the segments of the parabolic profile may be configured to be sufficiently large, such that the diffraction angle may be smaller than the angular resolution of human eyes. Thus, the diffraction effects may be unobservable by human eyes. As shown in FIG. 6D, the SPP LC lens 620 may include two substrates 612. One of the substrates 612 may be provided with a plurality of first electrodes 642, and the other of the substrates 612 may be provided with one or more second electrodes 646 (one second electrode 646 is shown in FIGS. 6D and 6E for illustrative purpose). An LC layer 644 may be disposed between the two substrates 612. The first electrodes 642 and the second electrode 646 may be transparent electrodes (e.g., ITO electrodes). The electrodes may be electrically connected with a power source, which may provide a voltage to the electrodes to generate an electric field in the LC layer 644. The electric field may re-orient the LC molecules in the LC layer 644 to form a lens having a predetermined phase profile. The SPP LC lens 620 may further include two alignment layers (not shown in FIG. 6D) provided between the first electrodes 642 and the LC layer 644 and between the second electrode 646 and the LC layer 644, respectively. The alignment layers may provide an alignments (e.g., indicated by the arrows in FIGS. 6D and 6E) to the LC molecules included in the LC layer 644.

In some embodiments, the first electrodes 642 may include discrete ring-shaped electrodes corresponding to the Fresnel structures in the SPP LC lens 620. The ring-shaped electrodes may be concentric with an identical area. That is, as the radii of the ring-shaped concentric electrodes increase, the width of the ring-shaped electrodes decreases, thereby maintaining the identical area. With this electrode geometry, the phase difference between neighboring Fresnel structures corresponding to neighboring first electrodes 642 may be the same. Accordingly, a parabolic phase profile may be obtained. Provided that the phase is proportional to the applied voltage, a linear change in the voltage across the first electrodes 642 (e.g., a same difference in voltage between any two first electrodes 642) may result in a parabolic phase profile of the SPP LC lens 620.

In some embodiments, the SPP LC lens 620 may be polarization sensitive (or selective). That is, the SPP LC lens 620 may selectively focus or defocus a light of a predetermined polarization, and may not focus or defocus of lights of other polarizations. For example, in the embodiment shown in FIG. 6D, the SPP LC lens 620 may provide an adjustable optical power to a linearly polarized input beam that is polarized in the y-axis direction (e.g., a p-polarized input beam), and may function as a substantially optically uniform plate to a linearly polarized input beam polarized in an x-axis direction (e.g. an s-polarized input beam).

In some embodiments, the gaps between the first electrodes 642 may cause scattering of the image light, which may result in image degradation. To reduce or eliminate the image degradation, a plurality of floating electrodes may be used. As shown in FIG. 6E, a plurality of floating electrodes 648 may be disposed at the substrate 612 having the first electrodes 642. The floating electrodes 648 may be disposed over the first electrodes 642. An insulating layer 650 may be disposed between the floating electrodes 648 and the first electrodes 642. The floating electrodes 648 may include discrete and concentric ring electrodes which may not be driven by an ohmic connection but may be capacitively coupled to the first electrodes 642. The floating electrodes 648 may be configured to cover an area of each of neighboring first electrodes 642. The insulating layer 650 may be configured to provide an electrical insulation to the first electrodes 642 and the floating electrodes 648.

FIG. 6F illustrate a schematic diagram of Fresnel structures of the SPP LC lens 620 shown in FIGS. 6D and 6E, according to an embodiment of the present disclosure. As shown in FIG. 6F, the Fresnel structure of the SPP LC lens 620 is represented by a plurality of concentric ring-shaped zones 635a, 635b, 635c, and 635d of increasing radii, which are referred as Fresnel segments or Fresnel resets. For a positive thin lens, an optical path difference (“OPD”) is approximated with Maclaurin series to a parabolic profile as shown in Equation (1):

$$O P D ( r ) = \frac{- {r}^{2}}{2 f} , \qquad ( 1 )$$

where r is the lens radius (i.e., half of the lens aperture) and f is the focal length. The OPD of an LC lens is proportional to the cell thickness d and the birefringence Δn of the LC material as shown in Equation (2):

OPD=d*Δn (2),

The response time τ of an Electrically Controlled Birefringence (“ECB”) LC cell, which is the time the material takes to recover to its original state, is quadratically dependent on cell thickness d (τ∞d²) as shown in Equation (3):

$$τ = \frac{γ \times {d}^{2}}{{K}_{11} \times {π}^{2}} , \qquad ( 3 )$$

where γ and K₁₁ are the rotational viscosity and the splay elastic constant of the LC material, respectively. Equations (1)-(3) show that there is a trade-off between the aperture size and response time, and thus it is challenging to design an LC lens with a large aperture and a reasonable response time. Through introducing phase resets in the parabolic phase profile, e.g., using an SPP LC lens, the LC lens 620 may be configured with a large aperture size without compromising the response time.

FIGS. 6B-6F illustrate exemplary configurations of the LC lens 620 that is linear polarization selective. In some embodiments, the linear polarization selective LC lens 620 may have other suitable configurations, which are not shown in the figures. Referring to FIG. 6A-6F, an overall optical power of the polarization selective lens assembly 600 may be a sum of the optical powers of the individual LC lenses 620 included in the polarization selective lens assembly 600. In some embodiments, a controller (e.g., the controller 120 shown in FIGS. 1A-1D) may be configured to individually or independently control the voltages applied to the LC lenses 620, thereby individually or independently controlling the optical powers provided by the LC lenses 620. Thus, the lensing state of the polarization selective lens assembly 600 may be switchable to adjust the overall optical power of the polarization selective lens assembly 600.

Referring back to FIG. 6A, a p-polarized input beam 602 may be incident on the first LC lens 620 (e.g., the lens 620 labelled as LC1). The controller (not shown in FIG. 6A) may be configured to individually or independently control the voltages applied to the LC lenses 620, such that the polarization selective lens assembly 600 may operate in one of the lensing states, e.g., to focus the p-polarized input beam 602 as a p-polarized beam 604. In some embodiments, the polarization selective lens assembly 600 may further include a polarization switch 610 disposed after the LC lens 620 (e.g., the lens 620 labelled as LC3) in the propagation direction of the p-polarized beam 604. The polarization switch 610 may include an SHWP or a twisted-nematic liquid crystal (“TNLC”) cell. The controller may be configured to control the polarization switch 610 to operate in a switching state to convert the p-polarized beam 604 output from the LC lens 620 (e.g., the lens 620 labelled as LC3) into an s-polarized beam, or to operate in a non-switching state to maintain a polarization of the p-polarized beam 604. Thus, the polarization selective lens assembly 600 may be configured to output a linearly polarized beam 606 having a desirable convergence or divergence and a desirable polarization.

FIG. 7A schematically illustrates a diagram of a polarization selective steering assembly 700, according to an embodiment of the present disclosure. The polarization selective steering assembly 700 may be linear polarization selective. The polarization selective steering assembly 700 may be an embodiment of the polarization selective steering assembly 110 included in the beam steering device 100 shown in FIG. 1A or the beam steering device 190 shown in FIG. 1D. As shown in FIG. 7A, the polarization selective steering assembly 700 may include one or more LC steering elements 720 arranged in an optical series (e.g., in a stack). At least one of the one or more LC steering elements 720 may be linear polarization selective. For illustrative purposes, FIG. 7A shows that the polarization selective steering assembly 700 includes three LC steering elements 720 (e.g., labelled as LC1 to LC3) arranged in an optical series in a stack.

FIG. 7B schematically illustrates a diagram of the LC steering element 720 included in the polarization selective steering assembly 700 shown in FIG. 7A, according to an embodiment of the present disclosure. In some embodiments, the LC steering element 720 may include an LC grating (also referred to as 720 for discussion purposes). As shown in FIG. 7B, the LC grating 720 may include an upper substrate 710 and a lower substrate 715 arranged opposing (e.g., facing) one another. In some embodiments, at least one (e.g., each) of the upper substrate 710 or the lower substrate 715 may be provided with a transparent electrode (e.g., an ITO electrode) at a surface (e.g., an inner surface) of the substrate for supplying an electric field to the LC grating 720. A power source 740 may be coupled with the transparent electrodes to supply a voltage for providing the electric field to the LC grating 720.

In some embodiments, the LC grating 720 may include a surface relief grating (“SRG”) 705 disposed at (e.g., bonded to or formed on) a surface of the lower substrate 715 facing the upper substrate 710. The SRG 705 may include a plurality of microstructures 705a, with sizes in micron levels or nano levels, which define or form a plurality of grooves 706. The microstructures 705a are schematically illustrated as solid black longitudinal structures, and the grooves 706 are shown as white portions between the solid black portions. The grooves 706 may be at least partially provided (e.g., filled) with an LC material 750. LC molecules 725 of the LC material 750 may have an elongated shape (represented by white rods in FIG. 7B). The LC molecules 725 may be aligned within the grooves 706, e.g., homeotropically aligned, homogeneously aligned, or both. The LC material 750 may have a first principal refractive index (e.g., n^{c}_{AN}) along a groove direction (e.g., an x-axis direction, length direction, or longitudinal direction) of the grooves 706. The LC material 750 may have a second principal refractive index (e.g., n⁰_{AN}) along an in-plane direction (e.g., a y-axis direction, width direction, or lateral direction) perpendicular to the groove direction of the SRG 705. The LC material 750 may be active LCs with LC directors re-orientable by an external field, e.g., the electric field provided by the power source 740. The active LCs may have a positive or negative dielectric anisotropy.

In some embodiments, as shown in FIG. 7B, the LC material 750 may include active LCs having a positive anisotropy, such as nematic liquid crystals (“NLCs”). The LC molecules 725 of the LC material 750 may be homogeneously aligned within the grooves 706 in the groove direction (e.g., x-axis direction). The second principal refractive index (e.g., n⁰_{AN}) may substantially match with a refractive index n_{g} of the SRG 705, and the first principal refractive index (e.g., n^{c}_{AN}) may not match with the refractive index n_{g} of the SRG 705. In some embodiments, the LC grating 720 may be linear polarization dependent. For example, referring to FIG. 7B, when a linearly polarized input beam 730 polarized in the groove direction (e.g., x-axis direction) is incident onto the LC grating 720, due to the refractive index difference between n^{c}_{AN} and n_{g}, the input beam 730 may experience a periodic modulation of the refractive index in the LC grating 720. As a result, the LC grating 720 may operate in a diffraction state to diffract the input beam 730 as a beam 735 having, e.g., a negative diffraction (steering) angle. In other words, the LC grating 720 may steer the input beam 730 counter-clockwise with respect to an initial input optical path of the input beam 730.

In some embodiments, the LC grating 720 may be an active grating, which may be directly switchable between a diffraction state (or an activated state) and a non-diffraction state (or a deactivated state) by an external field, e.g., an external electric field provided by the power source 740. A controller (e.g., similar to the controller 120 shown in FIGS. 1A-1D) may control an output (e.g., a voltage and/or current) of the power source 740. For example, by controlling the voltage output by the power source 740, the controller may control the switching of the LC grating 720 between the diffraction state and the non-diffraction state for the linearly polarized input beam 730 polarized in the groove direction (e.g., x-axis direction). When the LC grating 720 operates in the diffraction state for the linearly polarized input beam 730, the controller may adjust the voltage supplied by the power source 740 to the electrodes to adjust the diffraction efficiency of the LC grating 720. For example, when a voltage is supplied to the LC grating 720, an electric field (e.g., along a z-axis direction) may be generated between the parallel substrates 710 and 715. When the voltage is higher than a predetermined threshold voltage associated with the LC grating 720 and is gradually increased, the LC molecules 725 of LCs having the positive dielectric anisotropy may trend to be re-oriented by the electric field (e.g., may gradually become oriented parallel with the electric field direction). As the voltage changes, for the linearly polarized input beam 730 polarized in the groove direction (e.g., x-axis direction), the modulation of the refractive index nm (i.e., the difference between n^{c}_{AN} and n_{g}) provided by the LC grating 720 to the beam 730 may change accordingly, which in turn may change the diffraction efficiency. When the voltage is sufficiently high, directors of the LC molecules 725 of LCs having the positive dielectric anisotropy may be re-oriented to be parallel with the electric field direction (e.g., z-axis direction). Due to the substantial match between the refractive indices n⁰_{AN} and n_{g}, the LC grating 720 may function as a substantially optically uniform plate for the input beam 730 polarized in the groove direction. Thus, the LC grating 720 may operate in a non-diffraction state to transmit the input beam 730 therethrough as a beam 790 with substantially zero or negligible diffraction. In other words, the LC grating 720 operating in the non-diffraction state may not steer the linearly polarized input beam 730 polarized in the groove direction (e.g., x-axis direction).

In the embodiment shown in FIG. 7B, for the linearly polarized input beam 730 polarized in the groove direction (e.g., the beam 730 may be a p-polarized beam), the LC grating 720 is configured to operate in the diffraction state to diffract (or steer) the beam 730 (e.g., a polarized beam) as the beam 735 (e.g., a polarized beam) when the voltage supplied by the power source 740 is lower than or equal to the threshold voltage, or operate in the non-diffraction state to transmit the beam 730 (e.g., a polarized beam) with negligible diffraction when the voltage is sufficiently higher than the predetermined threshold voltage. For a linearly polarized input beam polarized in the in-plane direction perpendicular to the groove direction (e.g., an s-polarized beam), due to the substantial match between the refractive indices n⁰_{AN} and n_{g}, the LC grating 720 may function as a substantially optically uniform plate independent of the voltage. That is, the LC grating 720 may substantially transmit, with no or negligible diffraction (or steering), the input beam linearly polarized in the in-plane direction perpendicular to the groove direction.

FIG. 7C schematically illustrates a diagram of the LC steering element 720 included in the polarization selective steering assembly 700 shown in FIG. 7A, according to an embodiment of the present disclosure. In some embodiments, the LC steering element 720 may include an LC grating (also referred to as 720 for discussion purposes). As shown in FIG. 7C, the LC grating 720 may be a holographic polymer-dispersed liquid crystal (“H-PDLC”) grating, which may be fabricated by polymerizing an isotropic photosensitive liquid mixture of monomers and LCs under a laser interference irradiation. As shown in FIG. 7C, the LC grating 720 may include layers of LC droplets 712 embedded in a polymer matrix 714 disposed between two substrates 710. Each substrate 710 may be provided with a transparent conductive electrode 708. At least one of the two electrodes 708 may be disposed with an alignment layer (not shown), which may be configured to homogeneously (or horizontally) align LC molecules 725 in a predetermined alignment direction, e.g., a y-axis direction in FIG. 7C. An ordinary refractive index n₀ of the LCs within the LC droplets 712 may be sufficiently close to the refractive index nₚ of the material of the polymer matrix 714, and an extraordinary refractive index ne of the LCs within the LC droplets 712 may be substantially different from the refractive index nₚ of the material of the polymer matrix 714. Due to the refractive index difference between the extraordinary refractive index ne of the LCs and the refractive index nₚ of the material of the polymer matrix 714, the spatial modulation of the LCs may produce a spatially periodic modulation in the average refractive index of the LC grating 720.

In some embodiments, the LC grating 720 shown in FIG. 7C may be linear polarization dependent. For example, when a linearly polarized input beam 730 polarized in the predetermined alignment direction (e.g., the y-axis direction) is incident onto the LC grating 720, due to the refractive index difference between ne and nₚ, the beam 730 may experience a periodic modulation of the refractive index in the LC grating 720. As a result, the LC grating 720 may operate in a diffraction state to diffract the input beam 730 as a beam 735 having, e.g., a negative diffraction (steering) angle. In other words, the LC grating 720 may steer the input beam 730 counter-clockwise with respect to an initial input optical path of the input beam 730. In some embodiments, the LC droplets 712 are sufficiently small (dimensions in sub-wavelength ranges) so that the scattering caused by the refractive index mismatch of the LC and polymer may be minimized, and phase modulation may play a primary role. In some embodiments, the LC grating 720 may be an active grating, which may be directly switchable between a diffraction state (or an activated state) and a non-diffraction state (or a deactivated state) by an external field, e.g., an external electric field provided by the power source 740. A controller (e.g., similar to the controller 120 shown in FIGS. 1A-1D) may control an output (e.g., a voltage and/or current) of the power source 740. For example, by controlling the voltage output by the power source 740, the controller 215 may control the switching of the LC grating 720 between the diffraction state and the non-diffraction state. For example, when a voltage is supplied to the LC grating 720, an electric field (e.g., along a z-axis direction) may be generated between the two opposingly disposed substrates 710. When the voltage is higher than the predetermined threshold voltage and is gradually increased (not shown in FIG. 7C), the LC molecules 725 of LCs having the positive dielectric anisotropy may trend to be re-oriented by the electric field (e.g., the LC directors may gradually become oriented parallel with the electric field direction). As the voltage changes, for the linearly polarized input beam 730 polarized in the predetermined alignment direction (e.g., the y-axis direction), the modulation of the refractive index nm (i.e., the difference between ne and nₚ) provided by the LC grating 720 to the beam 730 may change accordingly, which in turn may change the diffraction efficiency. When the voltage is sufficiently high, directors of the LC molecules 725 of LCs having the positive dielectric anisotropy may be re-oriented to be parallel with the electric field direction (e.g., z-axis direction). Due to the substantial match between the refractive indices no and n_{g}, the LC grating 720 may function as a substantially optically uniform plate for the input beam 730. That is, the LC grating 720 may operate in a non-diffraction state for the beam 730 polarized in the predetermined alignment direction (e.g., the y-axis direction), and may transmit the beam 730 therethrough with substantially zero or negligible diffraction.

In the embodiment shown in FIG. 7C, for the linearly polarized input beam 730 polarized in the predetermined alignment direction (e.g., the beam 730 may be a p-polarized beam), the LC grating 720 is configured to operate in the diffraction state to diffract (or steer) the polarized beam 730 as the polarized beam 735 when the voltage supplied by the power source 740 is lower than or equal to the predetermined threshold voltage, or operate in the non-diffraction state to transmit the polarized beam 730 with negligible diffraction when the voltage is sufficiently higher than the predetermined threshold voltage. For a linearly polarized input beam polarized in an in-plane direction (e.g., an x-axis direction) perpendicular to the predetermined alignment direction (e.g., for an s-polarized beam), due to the substantial match between the refractive indices no and nₚ, the LC grating 720 may function as a substantially optically uniform plate independent of the voltage. That is, the LC grating 720 may substantially transmit, with no or negligible diffraction (or steering), the input beam linearly polarized in the in-plane direction (e.g., an s-polarized beam).

FIGS. 7D and 7E schematically illustrate diagrams of the LC steering elements 720 included in the polarization selective steering assembly 700 shown in FIG. 7A, according to an embodiment of the present disclosure. In some embodiments, the LC steering element 720 may include an LC-based optical phased array (“OPA”) (also referred to as 720 for discussion purposes). As shown in FIG. 7D, the OPA 720 may include an LC layer 755 disposed between two substrates 710. Each substrate 710 may be provided with a transparent conductive electrode 708 or 718. In the embodiment shown in FIG. 7D, the electrode 708 (which may be disposed at the lower substrate 710) may be a planar electrode, and the electrode 718 (which may be disposed at the upper substrate 710) may be a patterned electrode including a plurality of sub-electrodes (e.g., a plurality of striped electrodes arranged in parallel). The power source 740 may supply a voltage to the two electrodes 708 and 718 to generate a vertical electric field in the LC layer 755 to re-orient the LC molecules 725. An alignment layer (not shown) may be disposed at an inner surface (a surface facing the LC layer 755) of at least one (e.g., each) of the two electrodes 708 and 718. The alignment layers may be configured with homogeneous anti-parallel alignment directions, e.g., y-direction in FIG. 7D, through which the LC molecules 725 may be oriented in anti-parallel directions at a voltage-off state (e.g., V=0, not shown in FIG. 7D).

In some embodiments, as shown in FIG. 7E, two electrodes 718 may be included. Each electrode 718 may be a patterned electrode including a plurality of sub-electrodes (e.g., a plurality of striped electrodes arranged in parallel). In the embodiments shown in FIG. 7E, the sub-electrodes of the lower electrode 718 may be substantially aligned with the sub-electrodes of the upper electrode 718. Although not shown, in some embodiments, the sub-electrodes of the lower electrode 718 may be partially offset from the sub-electrodes of the upper electrode 718.

Referring to FIGS. 7D and 7E, in some embodiments, the OPA 720 may include a plurality of 2π phase resets, e.g., 760-1 and 760-2. The lower electrode 718 may be applied with a uniform driving voltage. For example, the driving voltage may be grounded. For each 2π phase reset 760-1 or 760-2, the amplitudes of driving voltages applied to the sub-electrodes of the upper electrode 718 via the power source 740 may be configured to be progressively changed (e.g., decreased) from a leftmost sub-electrode 718L to a rightmost sub-electrode 718R. Thus, from a leftmost edge to a rightmost edge of the 2π phase reset 760-1 or 760-2, the amplitude of a generated electric field in the 2π phase reset 760-1 or 760-2 may gradually change (e.g., decrease). Accordingly, from the leftmost edge to the rightmost edge of the 2π phase reset 760-1 or 760-2, the orientation of the directors of the LC molecules 725 of LCs having the positive dielectric anisotropy may change from being substantially perpendicular to the surface of the substrate 710 to being substantially parallel to the surface of the substrate 710, as shown in FIG. 7E. As a result, the OPA 720 may operate in a diffraction state to diffract a linearly polarized input beam 730 polarized in the alignment direction (e.g., the y-axis direction) as a beam 736 having, e.g., a positive diffraction (steering) angle. In other words, the OPA 720 may steer the input beam 730 clockwise with respect to an initial input optical path of the input beam 730. When the amplitudes of driving voltages applied to the sub-electrodes of the upper electrode 718 is configured to be substantially uniform from the leftmost sub-electrode 718L to the rightmost sub-electrode 718R of the 2π phase reset 760-1 or 760-2, the orientation of the directors of the LC molecules 725 may be substantially the same. Thus, the OPA 720 may function as a substantially optically uniform plate for the input beam 730. That is, the OPA 720 may operate in a non-diffraction state for the beam 730 polarized in the alignment direction (e.g., the y-axis direction), and may transmit the beam 730 therethrough with substantially zero or negligible diffraction.

In the embodiment shown in FIGS. 7D and 7E, for the linearly polarized input beam 730 polarized in the alignment direction (e.g., a p-polarized beam), the OPA 720 is configured to operate in the diffraction state to diffract (or steer) the beam 730 as the polarized beam 736 when the amplitudes of driving voltages applied to the sub-electrodes of the upper electrode 718 are progressively changed (e.g., decreased) from the leftmost sub-electrode 718L to the rightmost sub-electrode 718R in the 2π phase reset 760-1 or 760-2, or operate in the non-diffraction state to transmit the beam 730 with negligible diffraction when the amplitudes of driving voltages applied to the sub-electrodes of the upper electrode 718 are substantially the same from the leftmost sub-electrode 718L to the rightmost sub-electrode 718R in the 2π phase reset 760-1 or 760-2. For a linearly polarized input beam polarized in an in-plane direction (e.g., an x-axis direction) perpendicular to the alignment direction (e.g., an s-polarized beam), the OPA 720 may substantially transmit, with no or negligible diffraction (or steering), the input beam 730 linearly polarized in the in-plane direction (e.g., an s-polarized beam).

FIGS. 7B-7E illustrate exemplary configurations of the polarization selective steering element 720 that is linear polarization selective. In some embodiments, the linear polarization selective steering element 720 may have other suitable configurations, which are not shown in the figures. Referring to FIG. 7A-7E, an overall steering angle of the polarization selective steering assembly 700 may be a sum of the steering angles of the individual polarization selective steering element 720 included in the polarization selective steering assembly 700. In some embodiments, a controller (e.g., the controller 120 shown in FIGS. 1A-1D) may be configured to individually or independently control the voltages applied to the polarization selective steering elements 720, thereby individually or independently controlling the steering angles provided by the polarization selective steering elements 720. Thus, the steering state of the polarization selective steering assembly 700 may be switchable. Accordingly, the overall steering angle provided by the polarization selective steering assembly 700 may be adjustable within a steering angle range.

Referring back to FIG. 7A, a p-polarized input beam 702 may be incident onto the first polarization selective steering element 720 (e.g., labelled as LC1). The controller (not shown in FIG. 7A) may be configured to individually or independently control the voltages applied to the polarization selective steering elements 720, such that the polarization selective steering assembly 700 may operate in one of the steering states, e.g., to steer the p-polarized input beam 702 as a p-polarized beam 704. In some embodiments, the polarization selective steering assembly 700 may further include a polarization switch 710 disposed after the last polarization selective steering elements 720 (e.g., labelled as LC3) in the stack of steering elements 720. The polarization switch 710 may include an SHWP or a TNLC cell. The controller may be configured to control the polarization switch 710 to operate in a switching state to convert the p-polarized beam 704 output from the polarization selective steering elements 720 into an s-polarized beam, or operate in a non-switching state to maintain a polarization of the p-polarized beam 704. Thus, the polarization selective steering assembly 700 may be configured to output a linearly polarized beam 707 having a desirable steering angle and a desirable polarization direction.

Referring back to FIGS. 1A-1D, FIG. 2, FIG. 4, FIG. 6A, and FIG. 7A, in the embodiments shown in FIGS. 1A-1D, the polarization selective lens assembly 115 or 145 including a plurality of polarization selective lenses arranged in an optical series may be optically coupled to the polarization selective steering assembly 110 or 140 including a plurality of polarization selective steering elements arranged in an optical series to form a stack. Although not shown, in some embodiments, the polarization selective lenses and the polarization selective steering elements may be alternately arranged to form the stack. For example, in FIG. 1A, linear polarization selective lenses and linear polarization selective steering elements may be alternately arranged to form the stack. In some embodiments, a polarization switch (e.g., an SHWP or a TNLC cell) may be disposed between a linear polarization selective lens and a neighboring linear polarization selective steering element. In FIG. 1B, circular polarization selective lenses and circular polarization selective steering elements may be alternately arranged to form the stack. A polarization switch (e.g., the SHWP 144) may be disposed between a circular polarization selective lens and a neighboring circular polarization selective steering element. The first waveplate 142 may be disposed between the stack and the reflector 105. In FIG. 1C, linear polarization selective lenses and circular polarization selective steering elements may be alternately arranged to form the stack. A linear polarization selective lens and a neighboring circular polarization selective steering element may form a sub-stack. In each sub-stack, a polarization switch (e.g., the SHWP 144) may be disposed between the linear polarization selective lens and the circular neighboring polarization selective steering element. In the sub-stack, a first waveplate (e.g., the third waveplate 142b) may be disposed between the polarization switch and the linear polarization selective lens, and a second waveplate (e.g., the first waveplate 142a) may be disposed between the circular polarization selective steering element and a next sub-stack (or the reflector 105). In other words, a sub-stack may include a polarization selective lens, a first waveplate (e.g., the third waveplate 142b), a polarization switch (e.g., the SHWP 144), a polarization selective steering element, and a second waveplate (e.g., the first waveplate 142a) arranged in an optical series. In FIG. 1D, circular polarization selective lenses and linear polarization selective steering elements may be alternately arranged to form the stack. A circular polarization selective lens and a neighboring linear polarization selective steering element may form a sub-stack. In each sub-stack, a polarization switch (e.g., the SHWP 144) may be disposed between the circular polarization selective lens and the neighboring linear polarization selective steering element. A first waveplate (e.g., the first waveplate 142) may be disposed between the polarization switch (e.g., the SHWP 144) and the linear polarization selective steering element, and a second waveplate (e.g., similar to the first waveplate 142) may be disposed the linear polarization selective steering element and a neighboring sub-stack.

The disclosed beam steering devices for providing a 3D beam steering may have numerous applications in a large variety of fields. For example, beam steering devices based on PVHs with a tunable in-plane pitch may be implemented in display and optics module to enable pupil steered augmented reality (“AR”), virtual reality (“VR”), and/or mixed reality (“MR”) display systems including, but not limited to, holographic near eye displays, retinal projection eyewear, and wedged waveguide displays. Pupil steered AR, /VR, and/or MR display systems include features such as compactness, a large field of view (“FOV”), a high system efficiency, and a small eye-box. Beam steering devices based on PVHs with a tunable in-plane pitch may be implemented in the pupil steered AR, VR, and/or MR display systems to enlarge the eye-box spatially and/or temporally. In some embodiments, beam steering devices based on PVHs with a tunable in-plane pitch may be implemented in AR, VR, and/or MR sensing modules to detect objects in a wide angular range to enable other functions. In some embodiments, the disclosed beam steering devices for providing a 3D beam steering may be implemented in AR, VR, and/or MR sensing modules to extend the FOV (or detecting range) of the sensors, improve detecting resolution or accuracy of the sensors, and/or reduce the signal processing time. The disclosed beam steering devices for providing a 3D beam steering may also be used in optical communications, e.g., to provide data transmission speeds at the level of Gigabyte/second and data transmission ranges at the level of kilometers. The 3D beam steering devices may also be used in microwave communications, 3D imaging and sensing (e.g., light beam detection and ranging), lithography, and 3D printing, etc. Some exemplary applications in AR, VR and MR fields will be explained below.

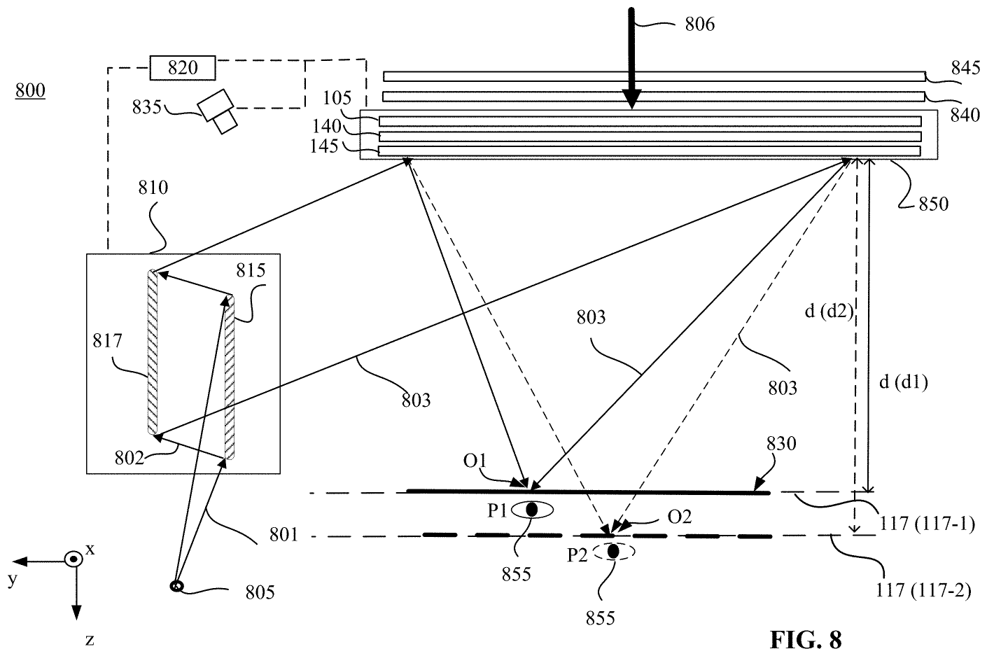

FIG. 8 schematically illustrates a diagram of a display system 800, according to an embodiment of the present disclosure. In some embodiments, the display system 800 may be a holographic display system. In some embodiments, the holographic display system may implemented in an NED for AR, VR, and/or MR applications. As shown in FIG. 8, the display system 800 may include a light source 805, a light conditioning device 810, a beam steering device 850, an eye-tracking device 835, and a controller 820. In some embodiments, the controller 820 may be similar to the controller 120 shown in FIGS. 1A-1D. Descriptions of the controller 820 can refer to the above descriptions of the controller 120 rendered in connection with FIGS. 1A-1D. The controller 820 may be electrically coupled with and control various devices in the display system 800, including, but not limited to, the light source 805, the eye-tracking device 835, and the beam steering device 850. In some embodiments, the light source 805 may include a point light source configured to generate a coherent or partially coherent beam 801 that is convergent or divergent. The light source 805 may include, e.g., a laser diode, a fiber laser, a vertical cavity surface emitting laser, a light emitting diode, or any combination thereof. The light conditioning device 810 may include one or more optical components configured to condition the beam 801 generated by the light source 805, and output a beam 803 with desirable properties toward the beam steering device 850. In some embodiments, conditioning the beam 801 may include, e.g., polarizing, expanding, and/or changing a propagation direction, etc., of the beam 801. In some embodiments, the controller 820 may control the light conditioning device 810 to condition the beam 801. In some embodiments, the light source 805 may include a single optical fiber coupled to three laser diodes emitting red, green, and blue laser beams, respectively. For example, the red, green, and blue laser beams may have a central wavelength of about 448 nm, 524 nm, and 638 nm, respectively. In some embodiments, the laser beams may be linearly polarized beams.

In some embodiments, the light conditioning device 810 may include a first optical element 815 and a second optical element 817. In some embodiments, the first optical element 815 may include a front HOE (also referred to as 815 for discussion purposes). In some embodiments, the second optical element 817 may include a spatial light modulator (“SLM”) (also referred to as 817 for discussion purposes). The front HOE 815 may be configured to reflect (e.g., backwardly diffract) the beam 801 received from the light source 805 as a beam 802 to illuminate the SLM 817, such that an optical path of the beam 801 from the light source 805 to the SLM 817 may be folded for achieving a compact form factor. In addition, the size of the front HOE 815 and the light source 805 may also be made sufficiently small to reduce the form factor. In some embodiments, the beam 802 directed by the front HOE 815 may cover an entire active area of the SLM 817. In some embodiments, the front HOE 815 may be configured to further expand the beam 801, such that the expanded beam may cover an entire active area of the SLM 817. In some embodiments, the front HOE 815 may include a fixed hologram configured to expand the beam 801 as the beam 802, and direct the expanded beam 802 to the SLM 817. The expanded beam 802 may cover the entire active area of the SLM 817. In some embodiments, the front HOE 815 may be angularly selective such that the front HOE 815 may substantially reflect (e.g., backwardly diffract) the beam 801 having an incidence angle within a predetermined incidence angle range, but may not reflect (e.g., backwardly diffract) a beam having an incidence angle outside of the predetermined incidence angle range. In some embodiments, the front HOE 815 may be multiplexed such that the front HOE 815 may be configured to have a high diffraction efficiency at multiple wavelengths, e.g., those within red, green, and blue spectrum, respectively. In some embodiments, the red, green, and blue beams may be centered at 448 nm, 524 nm, and 638 nm respectively.

The SLM 817 may be configured to modulate the beam 802 reflected (e.g., backwardly diffracted) from the front HOE 815. For example, the SLM 817 may be configured to modulate the amplitude, phase, and/or the polarization of the beam 802 in space and/or time, to provide a computer-generated hologram for generating a display image. Any suitable SLM 817 may be used. For example, the SLM 817 may include an LC material. In some embodiments, the SLM 817 may include a translucent or reflective LC micro display. In some embodiments, the SLM 817 may include a homeotropically aligned nematic LC cell, a homogeneously aligned nematic LC cell, or a twisted nematic LC cell. In some embodiments, the SLM 817 may be electrically programmed to modulate the beam 802 based on a fixed spatial (or pixel) pattern.

The modulated beam 803 corresponding to the hologram generated by the SLM 817 may be incident onto the beam steering device 850. The beam steering device 850 may be any beam steering device disclosed herein, such as the beam steering device 100 shown in FIG. 1A, the beam steering device 130 shown in FIG. 1B, the beam steering device 160 shown in FIG. 1C, or the beam steering device 190 shown in FIG. 1D. For discussion and illustrative purposes, FIG. 8 shows that the beam steering device 850 has a configuration similar to the beam steering device 130 shown in FIG. 1B. For example, the beam steering device 850 may include the reflector (e.g. HOE) 105, the first waveplate 142, the polarization selective steering assembly 140, the second waveplate 144, and the polarization selective lens assembly 145 arranged in an optical series, as shown in FIG. 1B.

The eye-tracking device 835 may be configured to provide eye-tracking information, based on which a position of an eye pupil 855 of a user of the display stem 800 may be determined. Any suitable eye-tracking device 835 may be used. The eye-tracking device 835 may include, e.g., one or more light sources that illuminate one or both eyes of the user, and one or more cameras that capture images of one or both eyes. The eye-tracking device 835 may be configured to track a position, a movement, and/or a viewing direction of the eye pupil 855. In some embodiments, the eye-tracking device 835 may measure the eye position and/or eye movement up to six degrees of freedom for each eye (i.e., 3D position, roll, pitch, and yaw). In some embodiments, the eye-tracking device 835 may measure a pupil size. The eye-tracking device 835 may provide a signal (or feedback) containing the position and/or movement of the eye pupil 855 to the controller 820.

The beam steering device 850 may be configured to provide a 3D beam steering. For example, the polarization selective steering assembly 140 may be configured to laterally steer (or shift), e.g., in an x-y place, the beam 803 relative to an input optical path of the beam 803 in one or two dimensions (e.g., an x-axis direction and/or a y-axis direction), and the polarization selective lens assembly 145 may be configured to vertically shift an image plane 117 at which the beam 803 is focused in a third dimension (e.g., in a z-axis direction). In some embodiments, based on the eye-tracking information from the eye-tracking device 835, the controller 820 may be configured to control the beam steering device 850 to steer and focus the beam 803 received from the SLM 817 to one or more spots at the image plane 117 where one or more exit pupils of the display system 800 is located. For discussion purposes, only one spot O1 is shown in FIG. 8. An exit pupil may be a location where an eye pupil 855 of a user is positioned in an eye-box region 830 of the display system 800. In some embodiments, one or more exit pupils may be simultaneously available at the eye-box 830. In some embodiments, one or more exit pupils may be arranged in a one-dimensional (“1D”) or a two-dimensional (“2D”) array within the eye-box 830. In some embodiments, one or more exit pupils simultaneously provided by the beam steering device 850 may be spaced apart, and one of the exit pupils may substantially coincide with a position of the eye pupil 855. That is, one of the spots may be directed into the eye pupil 855, such that the user may observe the display image generated by the SLM 817. In some embodiments, the exit pupils provided by the beam steering device 850 may be sufficiently spaced apart, such that when one of the exit pupils substantially coincides with the position of the eye pupil 855 (i.e., one of the spots falls onto the eye pupil 855), the remaining one or more exit pupils may be located beyond the position of the eye pupil 855 (e.g., falling outside of the eye 855).

For illustrative purposes, FIG. 8 shows two operating states of the beam steering device 850. For example, at a first time instance or period, the eye-tracking device 835 may detect that the eye pupil 855 is located at a first position P1 within the eye-box 830. Based on the eye-tracking information, the controller 820 may control the beam steering device 850 such that the polarization selective steering assembly 140 may operate at (e.g., be switched to) a first operating state (e.g., a first steering state), and the polarization selective lens assembly 145 may operate in a first lensing state. The beam 803 received from the light conditioning device 810 may be steered and focused by the beam steering device 850 to a first exit pupil O1 at a first image plane 117-1 having an image distance d1 from the reflector 105. The first exit pupil O1 may substantially coincide with the first position P1 of the eye pupil 855.

At a second time instance or period, the eye-tracking device 835 may detect that the eye pupil 855 has moved to a second position P2 at the eye-box 830. The eye-tracking device 835 may provide the new position information (as part of the eye-tracking information) to the controller 820. Alternatively, in some embodiments, the controller 820 may determine the new eye-tracking information based on images of the eye pupil 855 received from the eye-tracking device 835. The controller 820 may control the beam steering device 850 such that the polarization selective steering assembly 140 may switch to a second steering state (e.g., a second steering state) from the first steering state, and the polarization selective lens assembly 145 may switch to a second lensing state from the first lensing state. Thus, the beam 803 received from the light conditioning device 810 may be steered and focused by the beam steering device 850 to a second exit pupil O2 at a second image plane 117-2 having an image distance d2 from the reflector 105. The second exit pupil O2 may substantially coincide with the second position P2 of the eye pupil 855. As shown in FIG. 8, the image distance d2 is greater than the image distance d1, and the second exit pupil O2 has both a lateral shift (e.g., in the y-axis direction) and a vertical shift (e.g., in the z-axis direction) from the first exit pupil O1. Although not shown, in some embodiments, the second exit pupil O2 may have both a lateral shift (e.g., in the y-axis direction and/or in the x-axis direction) and a vertical shift (e.g., in the z-axis direction) from the first exit pupil O1. Thus, based on the eye-tracking information, the controller 820 may be configured to control the beam steering device 850 to steer the beam 803 received from the light conditioning device 810 in a 3D space based on a changing position of the eye pupil 855.

As discussed above in connection with FIG. 1B, in some embodiments, the image distance d may be adjustable through adjusting the optical power (or switching the lensing state) of the polarization selective lens assembly 145. An adjustment range for the image distance din the third dimension (e.g., in the z-axis direction) may be determined by an adjustment range of the overall optical power of the polarization selective lens assembly 145. In some embodiments, the adjustment range of the image distance din the third dimension (e.g., in the z-axis direction) provided by the beam steering device 850 may be configured to at least match a depth of the eye pupil 855 when the eye rotates around the nominal position. For example, a minimum value of the image distance d may be configured to be substantially equal to (or smaller than) to a minimum distance between the eye pupil 855 and the reflector 105 when the eye rotates around a nominal position, and a maximum value of the image distance d may be configured to be substantially equal to (or greater than) a maximum distance between the eye pupil 855 and the reflector 105 when the eye rotates around the nominal position. That is, the adjustment range of the image distance din the third dimension (e.g., in the z-axis direction) provided by the beam steering device 850 may be configured to account for an eye rotation around a nominal position. In some embodiments, the adjustment range of the image distance din the z-axis direction may be configured to at least match a variation in eye relief among different users. For example, a minimum value of the image distance d may be configured to be substantially equal to (or smaller than) a shortest eye relief among potential users, and a maximum value of the image distance d may be configured to be substantially equal to (or greater than) a longest eye relief among potential users.

In some embodiments, when used for AR applications, the beam steering device 850 may be substantially transparent to a beam 806 from a real world environment. The reflector 105 included in the beam steering device 850 may combine the beam 803 (an image light) and the beam 806 from a real-world environment, and direct both beams toward the eye-box 830. The reflector 105 may also be referred to as an image combiner (also referred to as 105 for discussion purposes). In some embodiments, the image combiner 105 may include an HOE. In some embodiments, the HOE may be configured to have a wide FOV. In some embodiments, the HOE may include a fixed hologram. In some embodiments, the HOE may include a volume (or Bragg) hologram configured to function over a narrow set of angles and wavelengths. In some embodiments, the HOE may be multiplexed to have a high diffraction efficiency at a plurality of wavelengths, (e.g., red, green, and blue wavelengths), thereby enabling a full color display. In some embodiments, the HOE may be angularly selective to an input beam and may be multiplexed with a plurality of holograms, such that the optical prescription of the HOE may change as a function of an incidence angle of the input beam. In some embodiments, the multiplexed holograms may be angularly selective to the incidence angle corresponding to the steering state of the polarization selective steering assembly 140 and the lensing state of the polarization selective lens assembly 145. In some embodiments, the optical prescriptions for respective multiplexed holograms may be designed to correct optical aberrations (e.g. pupil aberrations) for respective steering states of the polarization selective steering assembly 140 and respective lensing states of the polarization selective lens assembly 145.

In some embodiments, when used for AR and/or MR applications, in addition to a first stack of the polarization selective steering assembly 140 and the polarization selective lens assembly 145, the display system 800 may further include a second stack of a polarization selective steering assembly 840 and a polarization selective lens assembly 845. For example, the reflector 105 may have a first side facing the eye pupil 855 and a second side opposite to the first side. The first stack of the polarization selective steering assembly 140 and the polarization selective lens assembly 145 may be disposed at the first side of the reflector 105, and the second stack of the polarization selective steering assembly 840 and the polarization selective lens assembly 845 may be disposed at the second side of the reflector 105. The polarization selective steering assembly 840 and the polarization selective lens assembly 845 may be similar to the polarization selective steering assembly 140 and the polarization selective lens assembly 145, respectively. The controller 820 may be communicatively coupled with the polarization selective steering assembly 840 and the polarization selective lens assembly 845 to control operations thereof. In some embodiments, when used for AR and/or MR applications, the controller 820 may be configured to control the polarization selective steering assembly 840 and the polarization selective steering assembly 140 to provide opposite steering effects to the beam 806 from the real word environment. The controller 820 may control the polarization selective lens assembly 845 and the polarization selective lens assembly 145 to provide opposite lensing effects to the beam 806 from the real word environment. For example, the steering angles provided by the polarization selective steering assembly 840 and the polarization selective steering assembly 140 to the beam 806 may have opposite signs and a substantially same absolute value. The optical powers provided by the polarization selective lens assembly 845 and the polarization selective lens assembly 145 to the beam 806 may have opposite signs and a substantially same absolute value. Thus, the second stack of the polarization selective steering assembly 840 and the polarization selective lens assembly 845 may be configured to compensate for the distortion of the beam 806 (representing real-world images) caused by the first stack of the polarization selective steering assembly 140 and the polarization selective lens assembly 145, such that images of the real-world objects viewed through the display system 800 may be substantially unaltered.

In the disclosed embodiments, the beam steering device 850 may be configured to provide a 3D beam steering to an image beam (representing a virtual image). The polarization selective steering assembly 140 may be configured to provide a plurality of steering states to the beam 803 received from the light conditioning device 810. The plurality of steering states may correspond to a range of continuous or discrete adjustments of a steering angle (or diffraction angle) provided to the beam 803. The polarization selective lens assembly 145 may be configured to provide a plurality of lensing states to the beam 803. The plurality of lensing states may correspond to a range of continuous or discrete adjustments of an optical power provided to the beam 803. The range of continuous or discrete adjustments of the optical power provided to the beam 803 may correspond to an adjustment range of the image distanced of the image plane 117 at which the beam 803 is focused. The range of continuous or discrete adjustments of the steering angle (or diffraction angle) provided to the beam 803 may correspond to an adjustment range of a lateral position (e.g., x and y coordinates) of the spot O (at the image plane 117) to which the beam 803 is steered. Thus, a continuous or discrete shift of the exit pupil of the display system 800 may be provided in a 3D space to cover an expanded eye-box based on the eye-tracking information. In other words, a 3D pupil steering may be achieved. The beam steering device 850 may be compact with a thickness of a few millimeters to reduce the form factor of the display system 800. In addition, the beam steering device 850 may have a fast switching speed when switching between different steering states and/or between different lensing states. For example, a switching between different steering states and/or between different lensing states may take a few milliseconds, which may be sufficiently fast to keep pace with the movement of the eye pupil 855. Thus, the real-time eye tracking and real-time 3D shifting of the exit pupil positions may be provided.

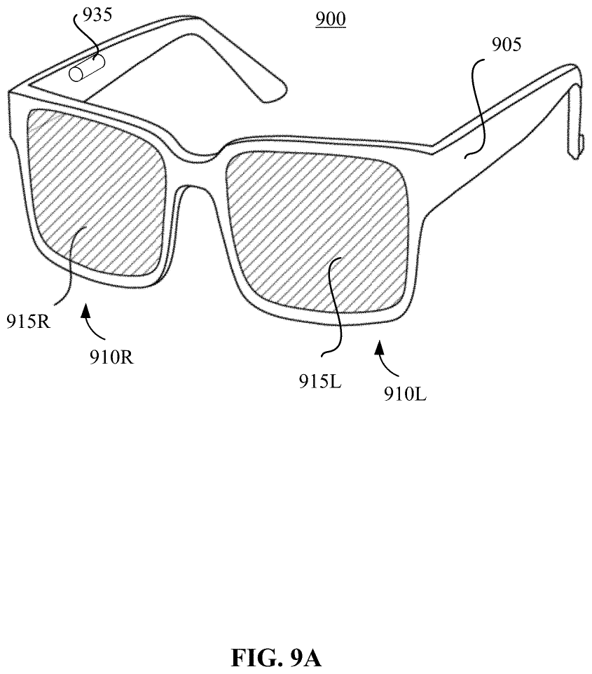

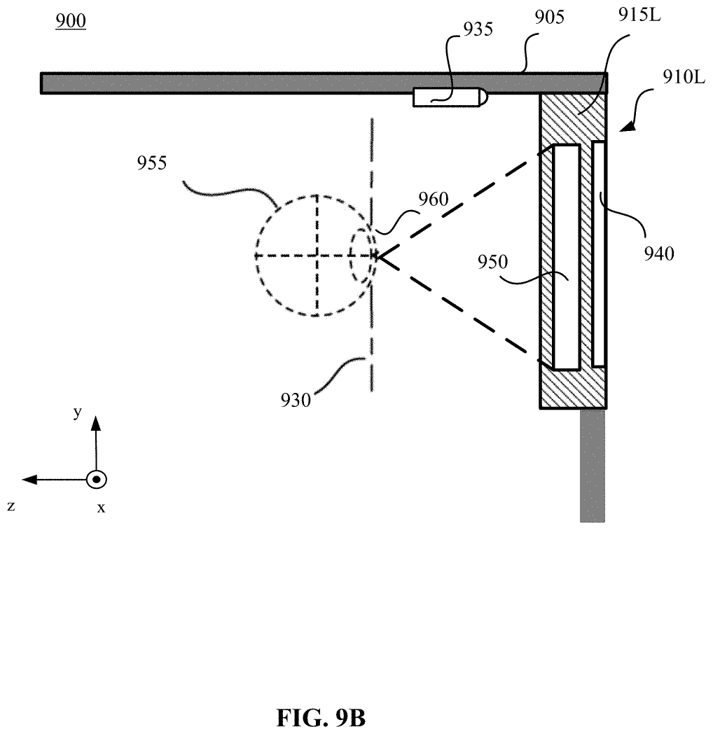

FIG. 9A illustrates a schematic diagram of a near-eye display (“NED”) 900 according to an embodiment of the disclosure. FIG. 9B is a cross-sectional view of half of the NED 900 shown in FIG. 9A according to an embodiment of the disclosure. For purposes of illustration, FIG. 9B shows the cross-sectional view associated with a left-eye display system 910L. The NED 900 may include the controller 120 or 820 and the eye-tracking device 835, which are not shown in FIG. 9A or 9B. As shown in FIGS. 9A and 9B, the NED 900 may include a frame 905 configured to mount to a user's head. The NED 900 may include right-eye and left-eye display systems 910R and 910L mounted to the frame 905. The right-eye and left-eye display systems 910R and 910L may include image display componentry configured to project computer-generated virtual images into left and right display windows 915L and 915R in a field of view (“FOV”). The right-eye and left-eye display systems 910R and 910L may be any display systems disclosed herein, such as the display system 800 shown in FIG. 8.

For illustrative purposes, FIG. 9A shows that the projection system may include a projector 935 coupled to the frame 905. The projector 935 may generate an image light representing a virtual image. As shown in FIG. 9B, the image light may be guided by the left-eye display system 910L to an exit pupil 960. The exit pupil 960 may be a location where an eye pupil 955 of the user is positioned in an eye-box region 930 of the left-eye display system 910L. Based on dynamically obtained eye-tracking information, the left-eye display system 910L including a beam steering device 950 may steer and focus the image light to different spots within the eye-box region 930, thereby changing the position of the exit pupil 960 to match with the changing positions of the eye pupil 935 of the eye 960. The beam steering device 950 may be any embodiment of the beam steering device disclosed herein. The NED 900 may function as a VR device, an AR device, an MR device, or any combination thereof. In some embodiments, when the NED 900 functions as an AR or an MR device, the right and left display windows 915R and 915L may be entirely or partially transparent from the perspective of the user, which may provide the user a view of a surrounding real-world environment. In some embodiments, when the NED 900 functions as a VR device, the right and left display windows 915R and 915L may be opaque, such that the user may be completely absorbed in the VR imagery based on computer-generated images. In some embodiments, the NED 900 may further include a dimming element 940, which may dynamically adjust the transmittance of real-world lights propagating through the right and left display windows 915R and 915L, thereby switching the NED 900 between a VR device and an AR device or between a VR device and an MR device. In some embodiments, along with switching between the AR/MR device and the VR device, the dimming element 940 may be used in the AR device to mitigate difference in brightness of real and virtual objects.

According to various embodiments, the present disclosure provides a device including a stack of a lens assembly and a steering assembly. The stack may be configured to receive a beam from a first side and output the beam from a second side. The lens assembly may be configured to provide an adjustable optical power to the beam. The steering assembly may be configured to provide an adjustable steering angle to the beam. The device may also include a reflector configured to receive the beam output from the second side of the stack, and reflect the beam back to the second side of the stack. The beam reflected back from the reflector may be incident onto the second side of the stack, and output from the first side of the stack to be focused at one or more spots with a predetermined region. The device may further include a controller configured to control the lens assembly to selectively provide one of a plurality of optical powers to the beam, and to control the steering assembly selectively to selectively provide one of a plurality of steering angles to the beam. The lens assembly may include a plurality of lenses arranged in an optical series, and at least one of the lenses may be a variable lens. The steering assembly may include a plurality of gratings arranged in an optical series, and at least one of the gratings may be a switchable grating. The beam may have a same first polarization when incident onto the lens assembly from two sides of the lens assembly. The beam may have a same second polarization when incident onto the steering assembly from two sides of the steering assembly. The first polarization may be the same as or different from the second polarization. In some embodiments, the reflector may include a holographic optical element. In some embodiments, the beam output from the second side of the stack may be linearly polarized, and the reflector may be configured to maintain a linear polarization of the beam output from the second side of the stack when reflecting the beam back to the second side of the stack. In some embodiments, the beam output from the second side of the stack may be circularly polarized, and the device may further include a waveplate disposed between the reflector and the stack and configured to convert a first circular polarization of the beam output from the second side of the stack into a linear polarization. The reflector may be configured to maintain the linear polarization of the beam when reflecting the beam back to the second side of the stack, and the waveplate may be configured to convert the linear polarization of the beam reflected back from the reflector into a second circular polarization orthogonal to the first circular polarization.

In some embodiments, the lens assembly and the steering assembly may be linear polarization selective. In some embodiments, the lens assembly and the steering assembly may be circular polarization selective. The device may also include a waveplate disposed between the reflector and the stack and configured to provide a quarter-wave retardance to the beam. The device may also include a polarization switch disposed between the steering assembly and the lens assembly and configured to switch or maintain a polarization of the beam.

In some embodiments, the lens assembly may be linear polarization selective and the steering assembly may be circular polarization selective. The device may also include a first waveplate disposed between the reflector and the stack and configured to provide a quarter-wave retardance to the beam. The device may also include a second waveplate disposed between the steering assembly and the lens assembly and configured to provide a quarter-wave retardance to the beam. The device may also include a polarization switch disposed between the second waveplate and the lens assembly and configured to switch or maintain a polarization of the beam.

In some embodiments, the lens assembly may be circular polarization selective and the steering assembly may be linear polarization selective. The device may also include a waveplate disposed between the steering assembly and the lens assembly and configured to provide a quarter-wave retardance to the beam. The device may also include a polarization switch disposed between the waveplate and the lens assembly and configured to switch or maintain a polarization of the beam.

According to various embodiments, the present disclosure provides a system including an eye tracking device configured to obtain eye tracking information of an eye pupil. The system may also include a beam steering device including a stack of a lens assembly and a steering assembly. The stack may be configured to receive a beam from a first side and output the beam from a second side. The beam steering device may also include a reflector configured to receive the beam output from the second side of the stack, and reflect the beam back to the second side of the stack. The beam reflected back from the reflector may be incident onto the second side and output from the first side of the stack. The system may further include a controller configured to control, based on the eye tracking information, the stack to adjust at least one of a steering angle provided by the steering assembly or an optical power provided by the lens assembly to steer the beam to the eye pupil.

In the system, the lens assembly may include a plurality of lenses arranged in an optical series, and at least one of the lenses may be a variable lens. The steering assembly may include a plurality of gratings arranged in an optical series, and at least one of the gratings may be a switchable grating. The beam may have a same first polarization when incident onto the lens assembly from two sides of the lens assembly. The beam may have a same second polarization when incident onto the steering assembly from two sides of the steering assembly. The first polarization may be the same as or different from the second polarization. In some embodiments, the reflector may include a holographic optical element. In some embodiments, the beam output from the second side of the stack may be linearly polarized, and the reflector may be configured to maintain a linear polarization of the beam output from the second side of the stack when reflecting the beam back to the second side of the stack. In some embodiments, the beam output from the second side of the stack may be circularly polarized, and the system may further include a waveplate disposed between the reflector and the stack and configured to convert a first circular polarization of the beam output from the second side of the stack into a linear polarization. The reflector may be configured to maintain the linear polarization of the beam when reflecting the beam back to the second side of the stack, and the waveplate may be configured to convert the linear polarization of the beam reflected back from the reflector into a second circular polarization orthogonal to the first circular polarization.

In some embodiments, in the system, the lens assembly and the steering assembly may be linear polarization selective. In some embodiments, the lens assembly and the steering assembly may be circular polarization selective. The system may also include a waveplate disposed between the reflector and the stack and configured to provide a quarter-wave retardance to the beam. The system may also include a polarization switch disposed between the steering assembly and the lens assembly and configured to switch or maintain a polarization of the beam.

In some embodiments, in the system, the lens assembly may be linear polarization selective and the steering assembly may be circular polarization selective. The system may include a first waveplate disposed between the reflector and the stack and configured to provide a quarter-wave retardance to the beam. The system may include a second waveplate disposed between the steering assembly and the lens assembly and configured to provide a quarter-wave retardance to the beam. The system may also include a polarization switch disposed between the second waveplate and the lens assembly and configured to switch or maintain a polarization of the beam.

In some embodiments, in the system, the lens assembly may be circular polarization selective and the steering assembly may be linear polarization selective. The system include a waveplate disposed between the steering assembly and the lens assembly and configured to provide a quarter-wave retardance to the beam. The system may also include a polarization switch disposed between the waveplate and the lens assembly and configured to switch or maintain a polarization of the beam.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or another embodiment not shown in the figures but within the scope of the present disclosure may include a plurality of such elements. Likewise, when an embodiment illustrated in a drawing shows a plurality of such elements, it is understood that the embodiment or another embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a stack of a lens assembly and a steering assembly, the stack configured to receive a beam from a first side and output the beam from a second side, wherein the lens assembly is configured to provide an adjustable optical power to the beam, and the steering assembly is configured to provide an adjustable steering angle to the beam; and
a reflector configured to receive the beam output from the second side of the stack, and reflect the beam back to the second side of the stack,
wherein the beam reflected back from the reflector is incident onto the second side of the stack, and output from the first side of the stack.

2. The device of claim 1, further comprising a controller configured to control the lens assembly to selectively provide one of a plurality of optical powers to the beam, and to control the steering assembly selectively to selectively provide one of a plurality of steering angles to the beam.

3. The device of claim 1, wherein the lens assembly and the steering assembly are linear polarization selective.

4. The device of claim 1, wherein the lens assembly and the steering assembly are circular polarization selective.

5. The device of claim 4, further comprising:
a waveplate disposed between the reflector and the stack and configured to provide a quarter-wave retardance to the beam; and
a polarization switch disposed between the steering assembly and the lens assembly and configured to switch or maintain a polarization of the beam.

6. The device of claim 1, wherein the lens assembly is linear polarization selective and the steering assembly is circular polarization selective.

7. The device of claim 6, further comprising:
a first waveplate disposed between the reflector and the stack and configured to provide a quarter-wave retardance to the beam;
a second waveplate disposed between the steering assembly and the lens assembly and configured to provide a quarter-wave retardance to the beam; and
a polarization switch disposed between the second waveplate and the lens assembly and configured to switch or maintain a polarization of the beam.

8. The device of claim 1, wherein the lens assembly is circular polarization selective and the steering assembly is linear polarization selective.

9. The device of claim 8, further comprising:
a waveplate disposed between the steering assembly and the lens assembly and configured to provide a quarter-wave retardance to the beam; and
a polarization switch disposed between the waveplate and the lens assembly and configured to switch or maintain a polarization of the beam.

10. The device of claim 1, wherein the beam has a same first polarization when incident onto the lens assembly from two sides of the lens assembly, and the beam has a same second polarization when incident onto the steering assembly from two sides of the steering assembly.

11. The device of claim 1, wherein the reflector includes a holographic optical element.

12. The device of claim 11, wherein the reflector is configured to maintain a linear polarization of the beam output from the second side of the stack when reflecting the beam back to the second side of the stack.

13. The device of claim 11, further comprising:
a waveplate disposed between the reflector and the stack and configured to convert a first circular polarization of the beam output from the second side of the stack into a linear polarization,
wherein the reflector is configured to maintain the linear polarization of the beam when reflecting the beam back to the second side of the stack, and
wherein the waveplate is configured to convert the linear polarization of the beam reflected back from the reflector into a second circular polarization orthogonal to the first circular polarization.

14. The device of claim 1, wherein
the lens assembly includes a plurality of lenses arranged in an optical series, at least one of the lenses being a variable lens, and
the steering assembly includes a plurality of gratings arranged in an optical series, at least one of the gratings being a switchable grating.

15. A system, comprising:
an eye tracking device configured to obtain eye tracking information of an eye pupil;
a beam steering device, comprising:
a stack of a lens assembly and a steering assembly, the stack configured to receive a beam from a first side and output the beam from a second side; and
a reflector configured to receive the beam output from the second side of the stack, and reflect the beam back to the second side of the stack,
wherein the beam reflected back from the reflector is incident onto the second side and output from the first side of the stack; and
a controller configured to control, based on the eye tracking information, the stack to adjust at least one of a steering angle provided by the steering assembly or an optical power provided by the lens assembly to steer the beam to the eye pupil.

16. The system of claim 15, wherein the beam has a same first polarization when incident onto the lens assembly from two sides of the lens assembly, and the beam has a same second polarization when incident onto the steering assembly from two sides of the steering assembly.

17. The system of claim 15, wherein the reflector includes a holographic optical element.

18. The system of claim 17, wherein the reflector is configured to maintain a linear polarization of the beam output from the second side of the stack when reflecting the beam back to the second side of the stack.

19. The system of claim 17, further comprising:
a waveplate disposed between the reflector and the stack and configured to convert a first circular polarization of the beam output from the second side of the stack into a linear polarization,
wherein the reflector is configured to maintain the linear polarization of the beam when reflecting the beam back to the second side of the stack, and
wherein the waveplate is configured to convert the linear polarization of the beam reflected back from the reflector into a second circular polarization orthogonal to the first circular polarization.

20. The system of claim 15, further comprising:
a first waveplate disposed between the reflector and the stack and configured to provide a quarter-wave retardance to the beam;
a second waveplate disposed between the steering assembly and the lens assembly and configured to provide a quarter-wave retardance to the beam; and
a polarization switch disposed between the second waveplate and the lens assembly and configured to switch or maintain a polarization of the beam.
